(19) United States
(12) Patent Application Publication
(10) Pub. No.: US 2024/0330693 A1
(43) Pub. Date: Oct. 3, 2024

(54) ACTIVE LEARNING FOR GRAPH NEURAL NETWORK BASED SEMANTIC SCHEMA ALIGNMENT

(71) Applicant: International Business Machines Corporation, Armonk, NY (US)

(72) Inventors: Abdul H. Quamar, Morgan Hill, CA (US); Xiao Qin, San Jose, CA (US); Berthold Reinwald, San Jose, CA (US); Venkata Vamsikrishna Meduri, Santa Clara, CA (US)

(21) Appl. No.: 18/191,024

(22) Filed: Mar. 28, 2023

(51) Int. Cl. G06N 3/091; G06N 3/045

(52) U.S. Cl. CPC G06N 3/091; G06N 3/045

(57) ABSTRACT

Embodiments are related to a technique for active learning for graph neural network based semantic schema alignment. The technique includes generating, by a first machine learning model executed on a processor, node embeddings having node pairs of a first schema and a second schema. The technique includes predicting, by a second machine learning model executed on the processor, a label output for the node pairs. The technique includes clustering the node pairs into a cluster output, determining that the label output and the cluster output are in a disagreement for at least one node pair of the node pairs, and in response to displaying the at least one node pair to a subject matter expert to generate a label for the at least one node pair, using the label for the at least one node pair as training data to further train the second machine learning model.

### BACKGROUND

The present invention generally relates to computer systems, and more specifically, to computer-implemented methods, computer systems, and computer program products configured and arranged for providing active learning for graph neural network based semantic schema alignment.

Machine learning models are computer programs that are used to recognize patterns in data and/or make predictions. Machine learning models are created from machine learning algorithms, which are trained using either labeled, unlabeled, or mixed data. Different machine learning algorithms are suited to different goals, such as classification or prediction modeling, so data scientists use different algorithms as the basis for different models. As data is introduced to a specific algorithm, it is modified to better manage a specific task and becomes a machine learning model. Since machine learning models are created by training algorithms with either labeled or unlabeled data, or a mix of both, as a result, there are three primary ways to train and produce a machine learning algorithm: supervised learning, unsupervised learning, and semi-supervised learning.

Supervised learning occurs when an algorithm is trained using “labeled data”, or data that is tagged with a label so that an algorithm can successfully learn from it. Training an algorithm with labeled data helps the eventual machine learning model know how to classify data in the manner that the researcher desires. Unsupervised learning uses unlabeled data to train an algorithm so that the algorithm finds patterns in the data itself and creates its own data clusters. Unsupervised learning is helpful for researchers who are looking to find patterns in data that are currently unknown to them. Semi-supervised learning uses a mix of labeled and unlabeled data to train an algorithm. In this process, the algorithm is first trained with a small amount of labeled data before being trained with a much larger amount of unlabeled data.

### SUMMARY

Embodiments of the present invention are directed to computer-implemented methods for active learning for graph neural network based semantic schema alignment. A non-limiting computer-implemented method includes generating, by a first machine learning model executed on a processor, node embeddings including node pairs of a first schema and a second schema. The computer-implemented method includes predicting, by a second machine learning model executed on the processor, a label output for the node pairs, clustering, by the processor, the node pairs into a cluster output, and determining, by the processor, that the label output and the cluster output are in a disagreement for at least one node pair of the node pairs. The computer-implemented method includes, in response to displaying the at least one node pair to a subject matter expert to generate a label for the at least one node pair, using, by the processor, the label for the at least one node pair as training data to further train the second machine learning model.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of the example computing environment configured with further details for providing active learning for graph neural network based semantic schema alignment according to one or more embodiments of the present invention;

FIG. 3A is a flowchart of a computer-implemented method for efficiently training machine learning models according to one or more embodiments of the present invention;

FIG. 3B is a flowchart of a computer-implemented method for efficiently training machine learning models according to one or more embodiments of the present invention;

FIG. 4 depicts two different knowledge graphs as semantic schemas/ontologies according to one or more embodiments of the present invention;

FIG. 5 depicts a block diagram of training a machine learning model according to one or more embodiments of the present invention;

FIG. 6 depicts an example algorithm for ontology aware semantic blocking according to one or more embodiments of the present invention;

FIG. 7 depicts a source semantic schema/ontology aligned to a target semantic schema/ontology (or vice versa) according to one or more embodiments of the present invention;

FIG. 8A depicts two clusters of nodes illustrating likely false positive and likely false negative according to one or more embodiments of the present invention;

FIG. 8B depicts example algorithms for determining disagreements in order to provide ambiguous node pairs according to one or more embodiments of the present invention;

FIG. 9A depicts two clusters of nodes illustrating similarity of matching between nodes across clusters according to one or more embodiments of the present invention;

FIG. 9B depicts two clusters of nodes illustrating similarity of non-matching between nodes across clusters according to one or more embodiments of the present invention;

FIG. 9C depicts example operations performed for ontology aware label propagation using the similarity found in FIGS. 9A and 9B according to one or more embodiments of the present invention;

FIGS. 10A and 10B depict ontology aware sample selection according to one or more embodiments of the present invention;

FIG. 11 is a flowchart of a computer-implemented method for active learning for graph neural network based semantic schema alignment and for training machine learning models according to one or more embodiments of the present invention;

FIG. 12 depicts an architecture of a GNN-based semantic schema alignment model to find matching elements across two input schemas according to one or more embodiments of the present invention;

FIG. 13A depicts example Algorithm 1 according to one or more embodiments of the present invention;

FIG. 13B depicts example Algorithm 2 according to one or more embodiments of the present invention;

FIG. 13C depicts example Algorithm 3 according to one or more embodiments of the present invention;

FIG. 13D depicts example Algorithm 4 according to one or more embodiments of the present invention;

FIG. 13E depicts example Algorithm 5 according to one or more embodiments of the present invention;

FIG. 13F depicts example Algorithm 6 according to one or more embodiments of the present invention;

FIG. 14A depicts two clusters of label propagation for matching pairs according to one or more embodiments of the present invention; and

FIG. 14B depicts two clusters of label propagation for non-matching pairs according to one or more embodiments of the present invention.

### DETAILED DESCRIPTION

One or more embodiments of the invention describe computer-implemented methods, computer systems, and computer program products configured and arranged to provide active learning for graph neural network based semantic schema alignment. Semantic schema alignment matches elements across a pair of schemas based on their semantic representation. It is a key primitive for artificial intelligence (AI)-driven data integration that facilitates the creation of a common data fabric across heterogeneous data sources. Deep learning approaches such as graph representation learning have shown promise for effective alignment of semantically rich schemas, often captured as ontologies. Most of these approaches are supervised and require large amounts of labeled training data, which is expensive in terms of cost, manual labor, and computer resources. Active learning (AL) techniques can alleviate this issue by intelligently choosing the data to be labeled utilizing a human-in-the loop approach, while minimizing the amount of labeled training data required, according to one or more embodiments.

However, existing active learning techniques are limited in their ability to utilize the rich semantic information of the underlying schemas to drive effective and efficient sample selection for human labeling, and existing active learning techniques cannot scale to larger datasets. In the present disclosure, an active learning framework (ALFA) is presented to overcome these limitations according to one or more embodiments. In accordance with one or more embodiments, ALFA exploits the schema element properties as well as the relationships between schema elements (structure) to drive a novel ontology aware sample selection and label propagation algorithm for training highly accurate alignment models. Further, one or more embodiments provide semantic blocking to scale to larger datasets without compromising model quality. For explanation purposes and not limitation, experimental results across three real-world datasets show that (1) ALFA leads to a substantial reduction (e.g., 27% to 82%) in the cost of human labeling, (2) semantic blocking reduces label skew up to 40 times without adversely affecting model quality and scales AL to large datasets, and (3) sample selection achieves comparable schema matching quality (e.g., 90% F1-score) to models trained on the entire set of available training data. Additionally, ALFA outperforms the state-of-the-art ontology alignment system, BERTMap, in terms of (1) 10 times shorter time per AL iteration and (2) requiring half of the AL iterations to achieve the highest convergent F1-score. BERTMap is a Bidirectional Encoder Representations from Transformers (BERT)-based ontology alignment system, which utilizes the textual knowledge of ontologies to fine-tune BERT and make prediction. An iteration is the process of proceeding through an active learning pipeline for training a model (e.g., classifier).

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as software code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

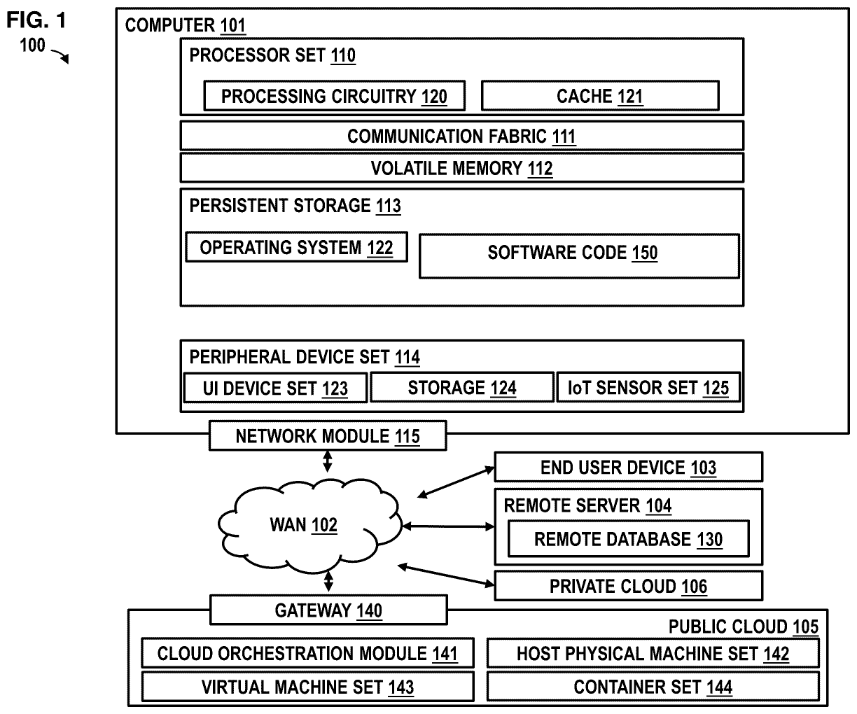

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images. deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The terms semantic schema, ontology, ontology graph, etc., may be utilized interchangeably and represent knowledge graphs of concepts/nodes. The terms nodes and concepts may be utilized interchangeably in relation to a graphs.

Terms pairs, node pairs, pairs of nodes, etc., can be utilized interchangeably to represent the two node/concepts taken from one or more knowledge graphs, where the pair of (two) node/concepts could be unlabeled or labeled (i.e., a match (√) or not a match (X).

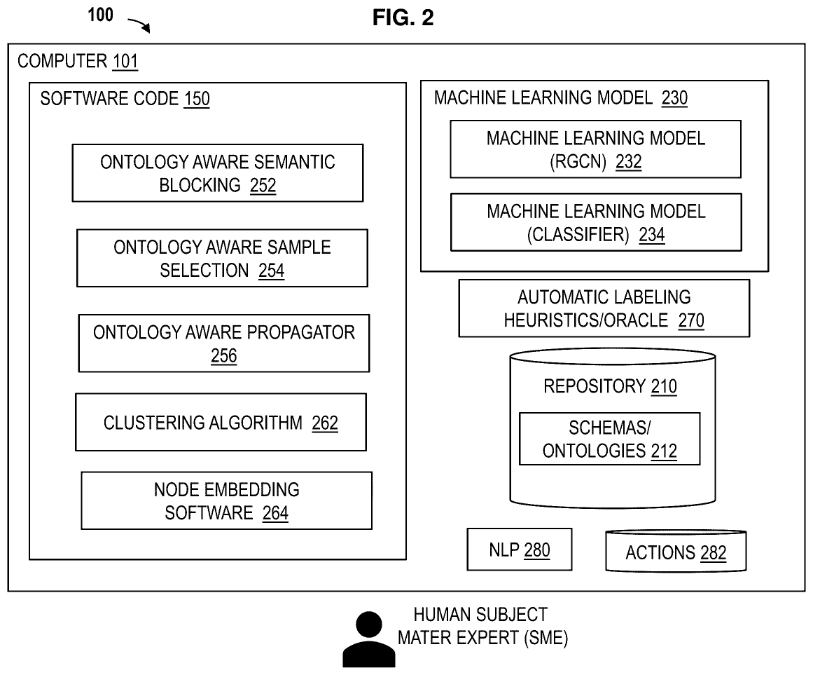

FIG. 2 depicts the computing environment 100 with further details for providing active learning for graph neural network based semantic schema alignment, which is then utilized for classification, according to one or more embodiments. In FIG. 2 and other figures herein, some details of the computing environment 100 may be omitted so as not to obscure the figure while new details are presented.

The computer 101 includes the software code 150 and a machine learning model 230. The machine learning model 230 can include machine learning model 232 and machine learning model 234. The machine learning model 232 can be implemented as a graph neural network, particularly a relational graph convolution network (RGCN). The RGCN is an application of the graph convolutional network (GCN) framework for modeling relational data, specifically to link prediction and entity classification tasks. The machine learning model 234 can be a classifier such as a multilayer perceptron (MLP). The MLP is a fully connected class of feedforward artificial neural network (ANN).

The software code 150 can include and/or be coupled to ontology aware semantic block software 252, ontology aware sample selection software 254, ontology aware propagator software 256, a clustering algorithm 262 (e.g., a machine learning model), and node embedding software 264.

The ontology aware semantic block software 252 includes one or more algorithms configured to prune away obvious mismatching pairs of nodes or concepts from between two semantic schemas or two ontologies that are to be aligned to one another. The ontology aware semantic block software 252 enhances scalability and decreases label skew of the dataset (e.g., the training dataset). Further, the ontology aware semantic block software 252 is configured to enable scaling of the active learning to large ontology graphs and has minimal impact on the accuracy of the trained machine learning model 230, according to one or more embodiments.

The ontology aware sample selection software 254 includes one or more algorithms configured to choose informative pairs of nodes/concepts to be labeled. The ontology aware sample selection software 254 iteratively strengthens the classifier and enhances the F1 score. Further, the ontology aware sample selection software 254 is configured to find pairs of nodes/concepts likely to be misclassified by the machine learning model 230 (e.g., the machine learning model 234), according to one or more embodiments. Also, the ontology aware sample selection software 254 is configured to exploits semantic name embeddings and ontology structure on both structure and semantics of the knowledge graph.

The ontology aware propagator software 256 is configured to infer labels for pairs of nodes/concepts not explicitly given to the human subject matter expert or oracle and is configured to reduce labeling cost (e.g., computer resources) that lead to early termination. The ontology aware propagator software 256 is configured to find pairs or nodes/concepts across different ontologies similar to the pairs of nodes/concepts labeled by the human subject matter expert or oracle and then propagate the labels of the pairs of nodes/concepts to the machine learning model 234 as further training data at an adaptive rate to minimize impact on the accuracy of the machine learning model 234.

The clustering algorithm 262 can be both ontology-aware and model-aware. The clustering algorithm 262 may include K-Means clustering that is applied on model-generated concept embeddings, which are the compact node embeddings generated by the machine learning model 232. The compact node embeddings are feature vectors.

In accordance with one or more embodiments discussed herein, the software code 150, machine learning model 230, and automatic labeling heuristics/oracle 270 may include computer readable program instructions or computer executable instructions cause a series of operational steps to be performed by processor set 110 of computer 101.

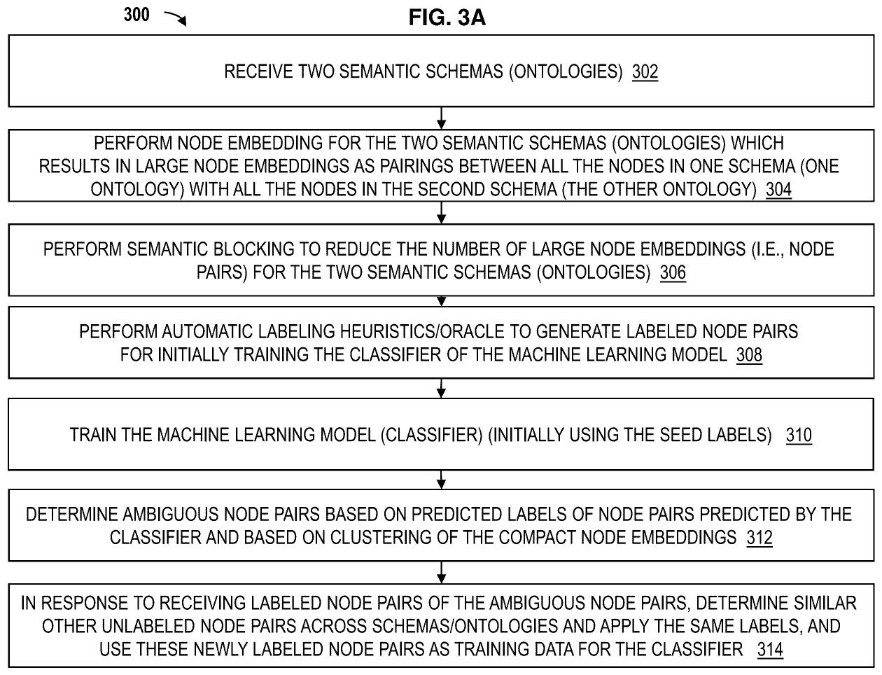

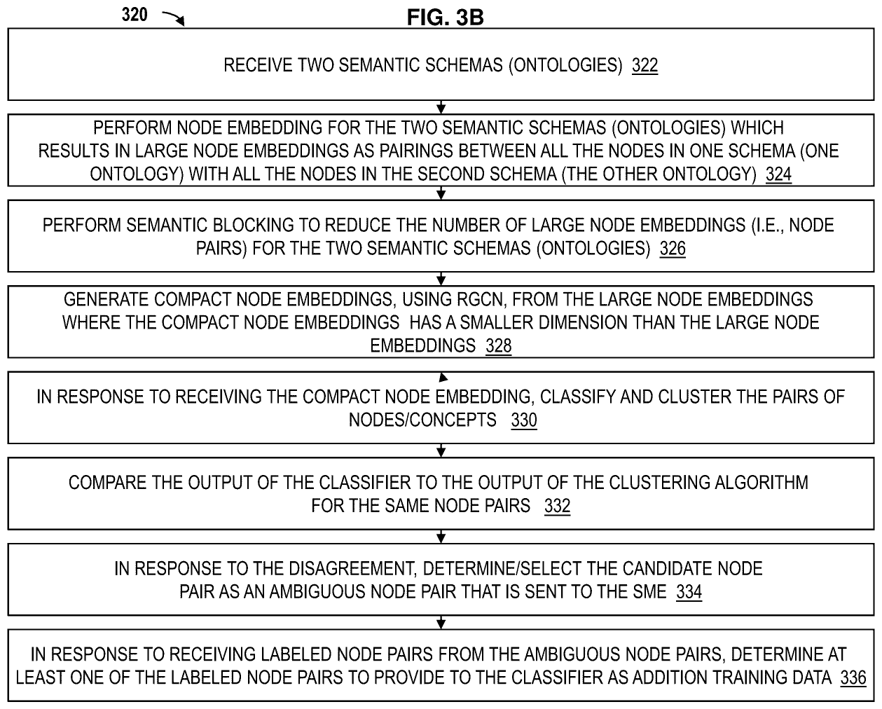

FIG. 3A is a flowchart of a computer-implemented method 300 for training the machine learning model 232 (e.g., RGCN) and the machine learning model 234 (e.g., classifier) according to one or more embodiments. The computer-implemented method 300 is executed by the computer 101. The training is performed such that the machine learning model 230 is trained to provide semantic schema network (ontology) alignment between two schemas/ontologies, thereby finding matching node/concept pairs across the two schemas/ontologies. The newly combined schemas/ontologies can be utilized for artificial intelligence operations, such as performing automated or semi-automated actions. Because the various newly combined schemas/ontologies, a (trained) natural language processor (NLP) model 280 can utilize any of the newly combined schemas/ontologies to receive, understand, and process questions, commands, gestures, and/or conversations from a user, and the NLP model 280 provides an output to the user. Based on the output from the NLP model 280, which has been determined from the newly combined schemas/ontologies, the NLP model 280 in conjunction with one or more application programming interfaces (APIs) is configured to cause the selection and execution of one or more automations/actions in the actions database 282. The selected automations/actions can include modifying, powering off, powering on, and/or restarting machinery, appliances, computer equipment, electrical motors, engines, lights, pumps, etc., as understood by one of ordinary skill in the art.

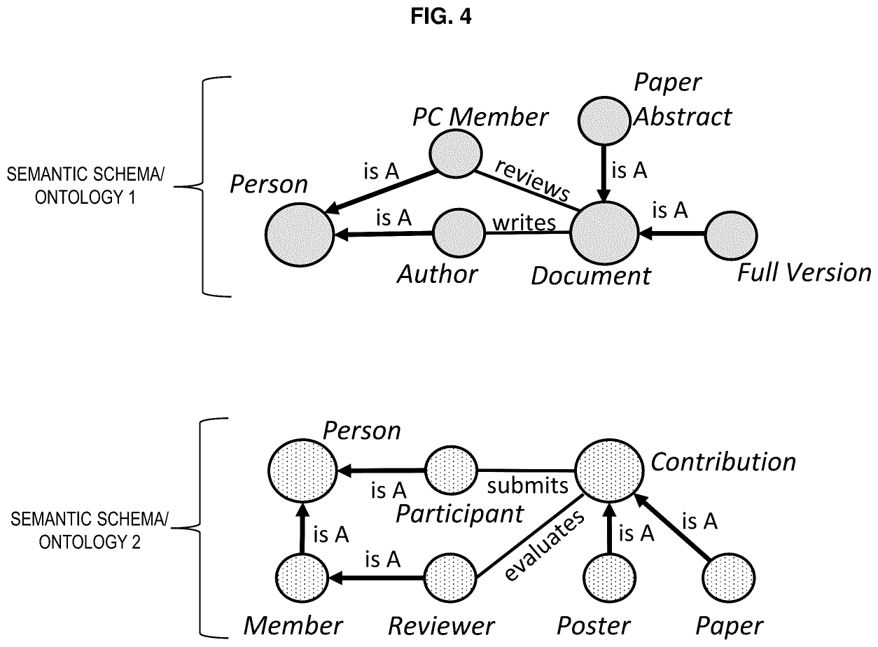

At block 302 of the computer-implemented method 300, the software code 150 is configured to receive two schemas/ontologies that need to be aligned. The two schemas/ontologies can be retrieved, pulled, or pushed from a repository 210 of numerous schemas/ontologies 212 that need to be aligned. For illustration purposes, FIG. 4 depicts two different knowledge graphs as semantic schema/ontology 1 and semantic schema/ontology 2, which are to be aligned.

At block 304, the software code 150 is configured to perform node embedding for the two semantic schemas/ontologies, which results in a very large node embedding. The large node embedding includes pairing between all the nodes/concepts in one schema/ontology with all the node/concepts in the other schema/ontology. Each node embedding is a feature vector of representing the node. The software code 150 may include, call, and/or employ the node embedding software 264. The node embedding software 264 can include and/or be implemented as any known node embedding software such as, for example, universal sentence encodings (USE) for concept nodes. When receiving two ontology graphs (as depicted in FIG. 4) with concept nodes as the input, the node embedding software 264 is configured to generate pairs of nodes (from both ontologies) for training data. The pairs of nodes include unlabeled matching and non-matching concept pairs of nodes for training. The node embedding software 264 generates a Cartesian product of node pairs from the two ontology graphs. The node embedding is simply based on plain (English) language as does not account for the semantic information in the two knowledge graphs. In one example, the resulting very large node embedding may have 512 dimensions (D), which means that a node can be represented by a feature vector having as many as 512 features or properties. It is noted that the pairs of nodes/concepts in the large node embedding are each unlabeled.

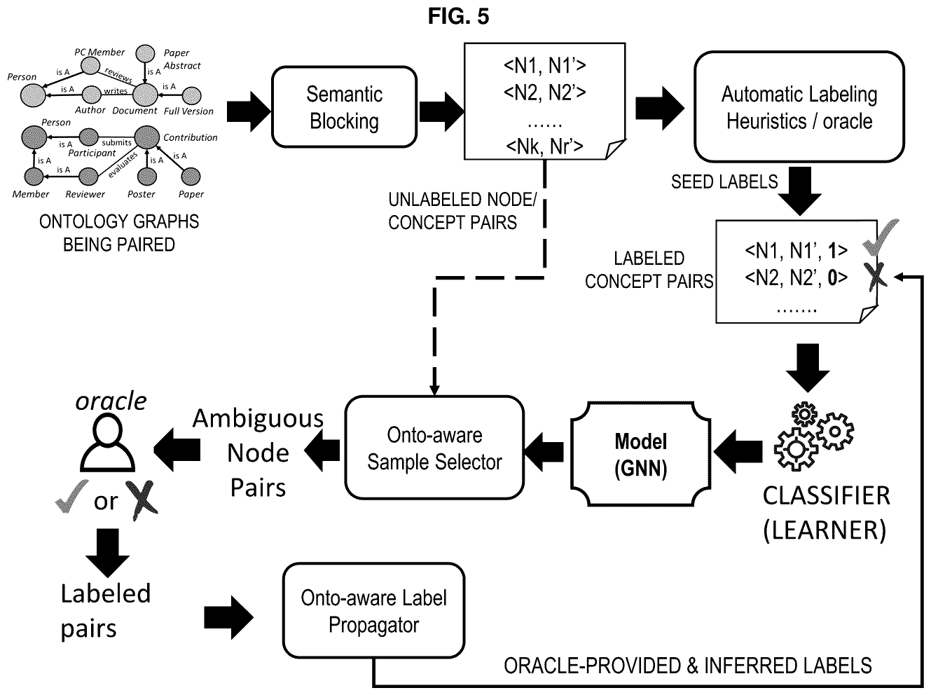

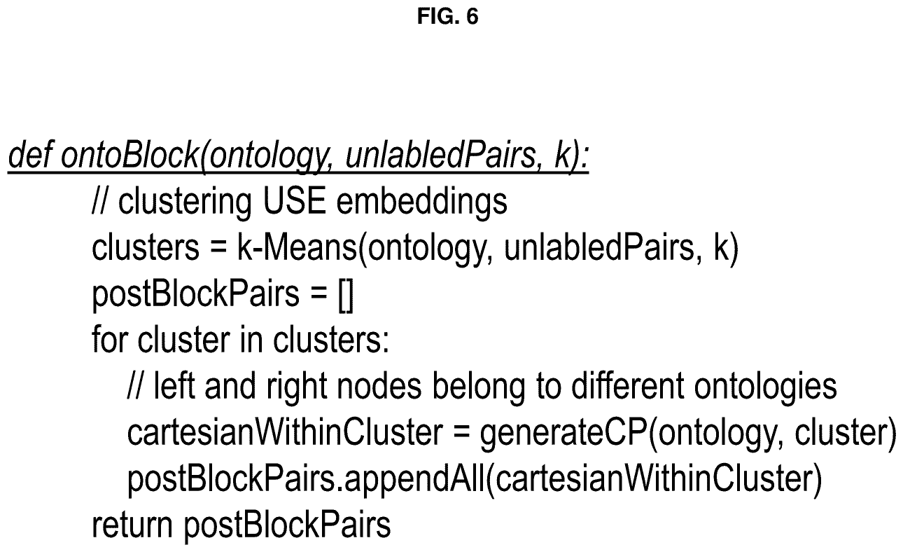

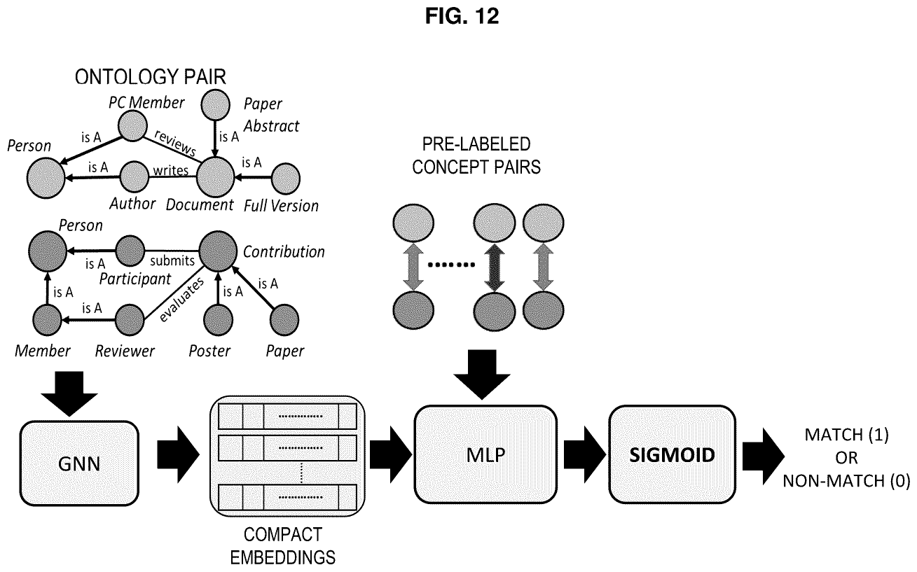

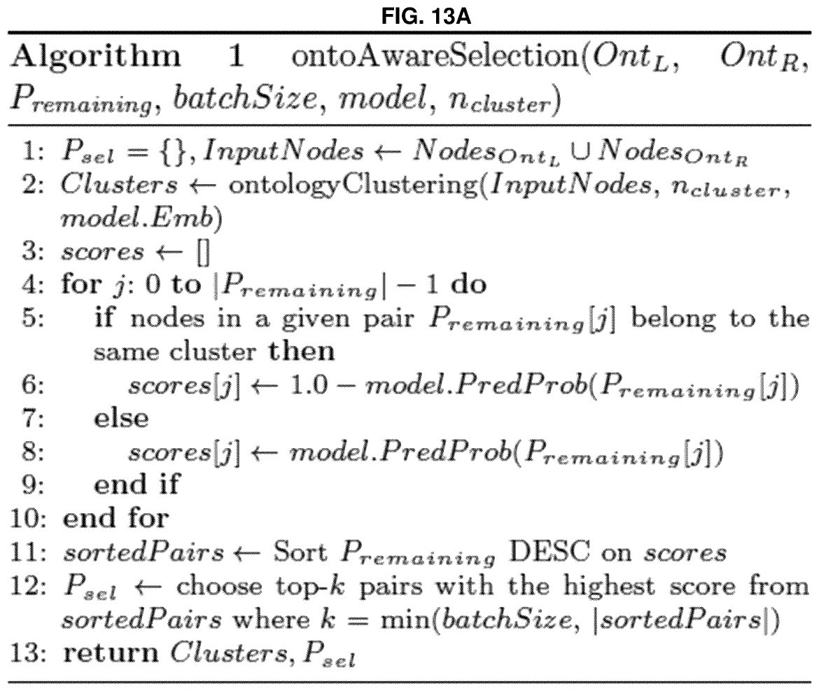

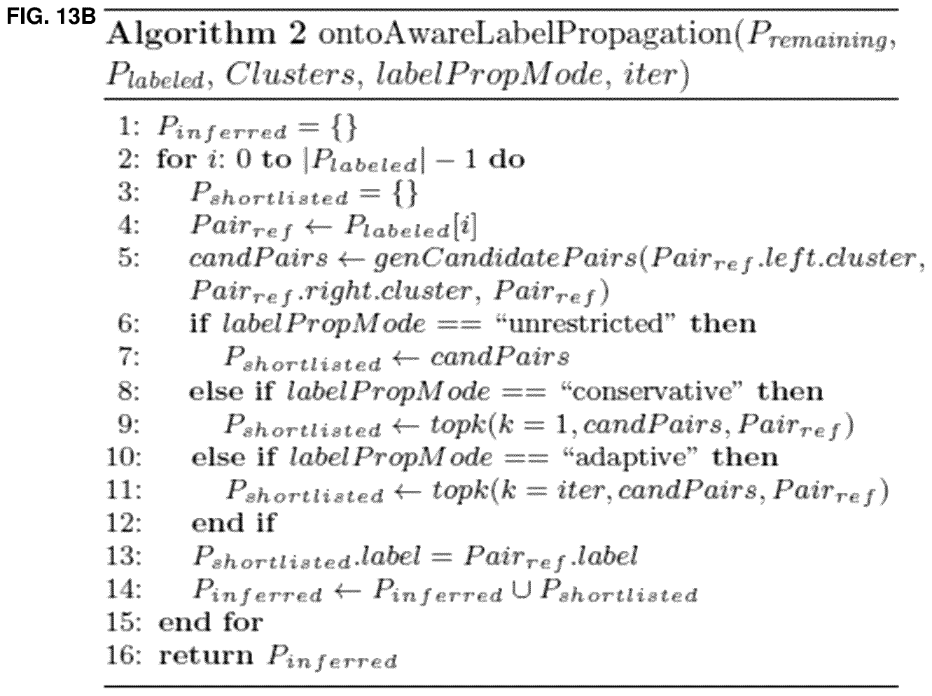

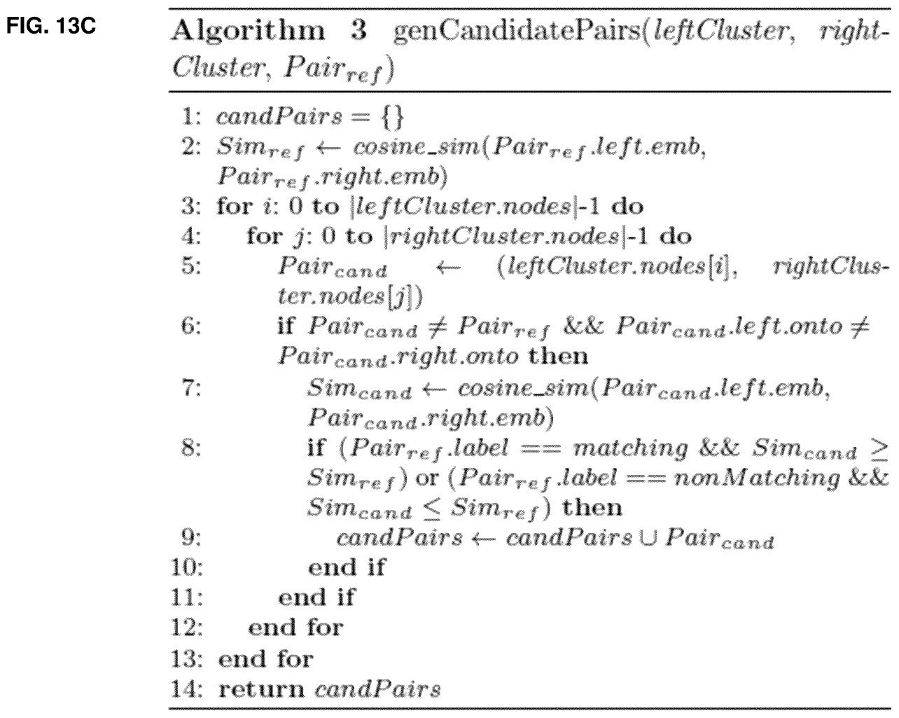

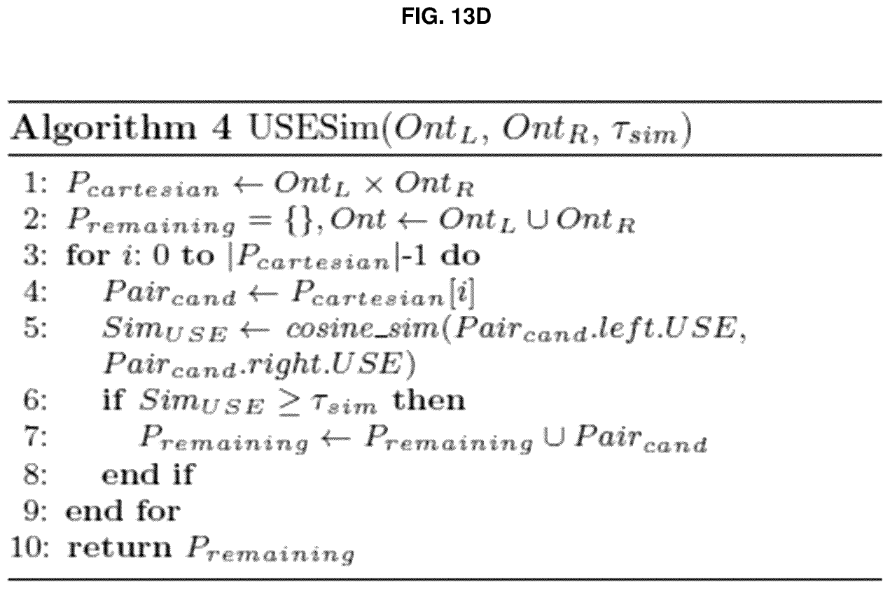

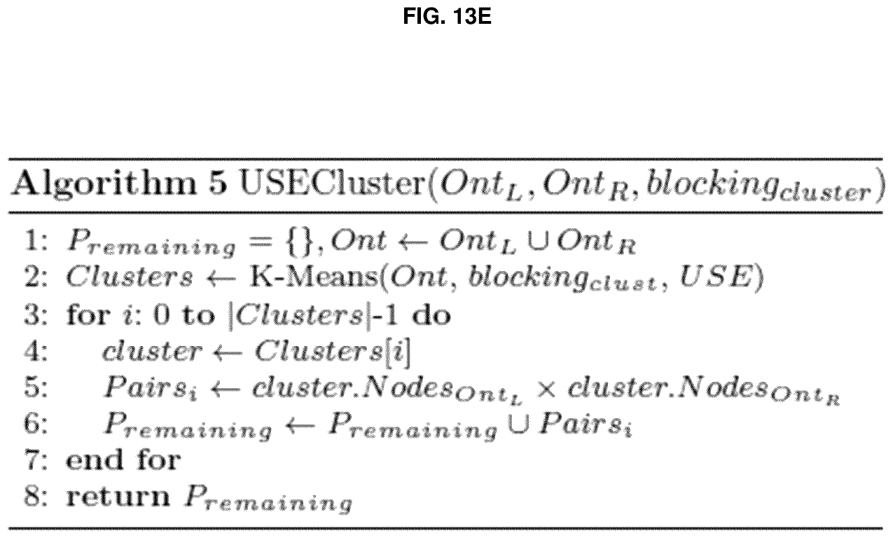

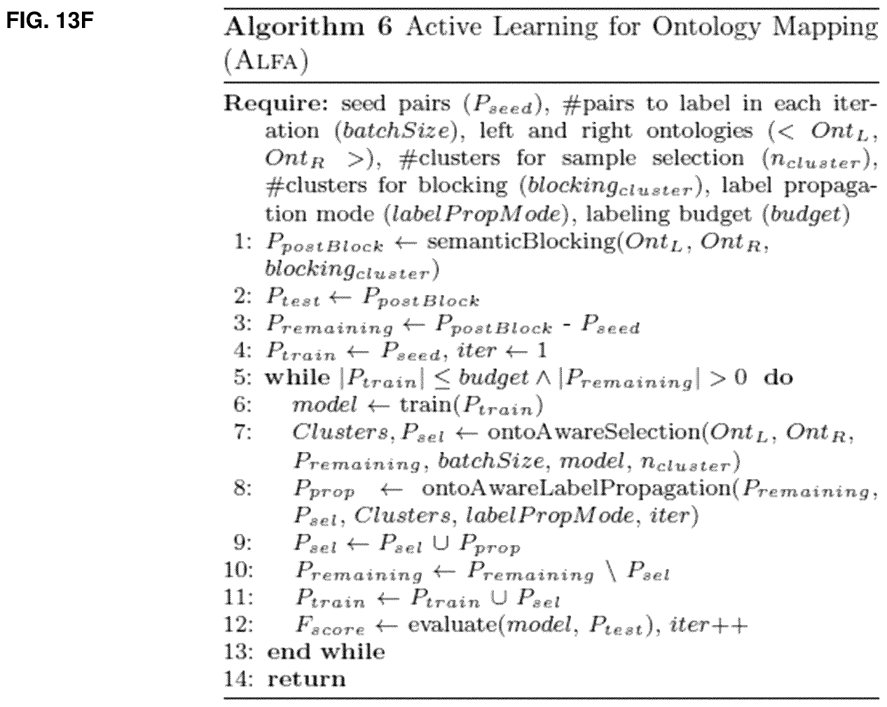

At block 306, the software code 150 is configured to perform ontology aware semantic blocking to reduce the number of node/concept pairs in the large node embedding. FIG. 5 depicts a block diagram of training the machine learning model 230 according to one or more embodiments. In FIG. 5, the pairs of nodes/concepts in the large node embedding are processed by semantic blocking. To perform the ontology aware semantic blocking, the software code 150 may include, call, and/or employ the ontology aware semantic block software 252. FIG. 6 illustrates an example algorithm for ontology aware semantic blocking according to one or more embodiments. In one or more embodiments, the ontology aware semantic block software 252 may perform clustering such as K-means clustering on the pairs of nodes/concepts in the large node embedding, which results in two clusters, for example. Any pair of nodes that does not lie within each of the two clusters is pruned away, i.e., all the cross-cluster pairs are deemed to be obvious mismatches. The ontology aware semantic block software 252 is designed for scalability by reducing the number (#) of unlabeled pairs and reducing the label skew. The ontology aware semantic block software 252 eliminates cross-cluster pairs that are labeled as mismatching. There can be trade-off between false negatives and skew. The semantic blocking is a one-time preprocessing step, where “k” is determined based on target number of post-blocking pairs. The value of “k” indicates the #blocking clusters, and this value needs to be pre-determined. Setting the value of “k” to a very low value gives fewer false negatives but lacks enough pruning power of obvious mis-matches, thereby leading to a high number of post-blocking pairs. Setting “k” to a higher value prunes several mis-matches thereby resulting in fewer post-blocking pairs, but it can lead to higher false negatives. This trade-off has been measured in FIG. 12 and FIG. 13 where “k” is shown as a percentage of the number of distinct nodes in the unified ontology graph. FIG. 13 shows that setting “k” to a value (i.e., an absolute value of 11 clusters) corresponding to 10% of the 116 distinct nodes in the CMT-CONF graph results in 300 target post-blocking pairs, whereas setting “k” to 30% blocking clusters leads to 75 target post-blocking pairs.

At block 308, initially, the software code 150 is configured to cause/request the automatic labeling of a small percentage of node/concept pairs in the large node embedding to result in seed labels (e.g., depicted in FIG. 5) of the small percentage of node/concept pairs, which are utilized for initially training the machine learning model 234 and the machine learning model 232. The software code 150 may call, employ, and/or instruct automatic labeling heuristics software 270 or oracle for providing the seed labels for the small percentage of node/concept pairs in the large node embedding. An example of the automatic labeling heuristics software 270 may be a rules-based algorithm. An example of an automatic labeling heuristics system is the Snorkel system which requires weak supervision in the form of vaguely defined rules, called as labeling functions, supplied by a human. These rules can be Disjunctive Normal Forms (DNFs) of Boolean predicates which can assign labels based on their evaluation. Such labeling functions help in learning a generative model called Snorkel which performs automatic labeling. This is one example of a semi-automatic labeling framework. An example of a rules-based logic system is the domain-specific expert system that uses rules to make deductions or choices. The rules-based logic includes a set of facts or source of data related to capturing objects, and a set of rules for manipulating that data. These rules are sometimes referred to as “If statements” as they tend to follow the line of “IF X happens THEN do Y.” In one or more embodiments, the oracle could be a human subject matter expert (SME).

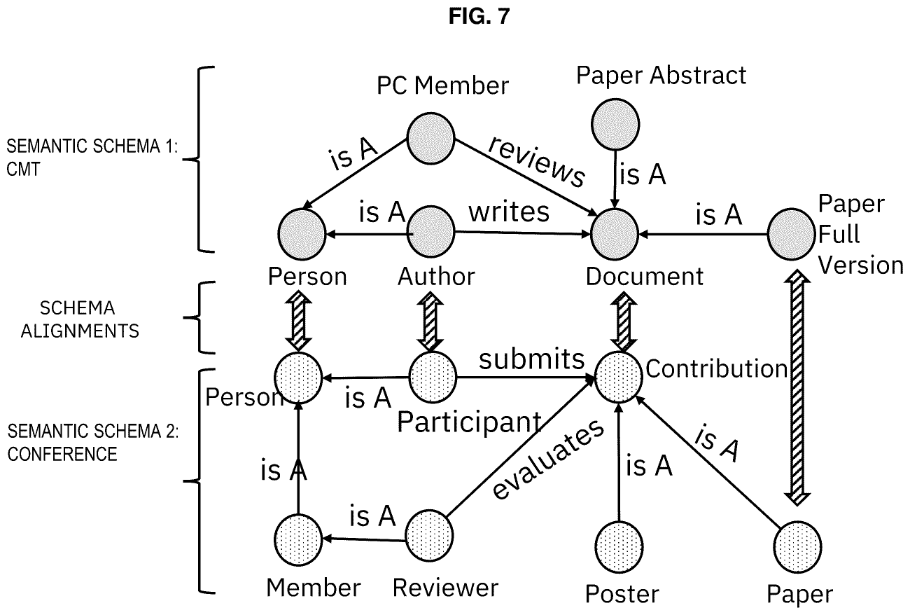

At block 310, initially, the software code 150 is configured to cause the training of the machine learning model 234, initially using the seed labels for the small percentage of node/concept pairs. The machine learning model 234 (classifier) learns the labels for node/concept pairs, where the labels are match and no match. The seed labels are either match or no match for the small percentage of node/concept pairs in the large node embedding for the two schemas/ontologies. It should be appreciated that there can be many iterations with different semantic schemas/ontologies taken from the semantic schemas/ontologies 212 in the repository 210, in order to train the machine learning model 234. As noted herein, the machine learning model 234 can be implemented as an MLP that classifies each node pair as a match or non-match, thereby aligning a node/concept in one schema/ontology with a node/concept in another schema/ontology resulting in the two semantic schemas/ontologies being aligned in a combined knowledge graph as depicted in FIG. 7. In FIG. 7, the schema alignments, denoted by arrows having diagonally striped lines, represent the nodes/concepts labeled as matches by the machine learning model 234. As depicted in FIG. 7, a source semantic schema/ontology is aligned to a target semantic schema/ontology or vice versa, where the nodes/concepts in one schema/ontology is the source while the nodes/concepts in the other schema/ontology is the target (or vice versa).

During training, the output of predicted labels for the node/concept pairs from the machine learning model 234 is provided to the ontology aware sample selector 254 along with unlabeled node/concept pairs from the semantic blocking, as depicted in FIG. 5.

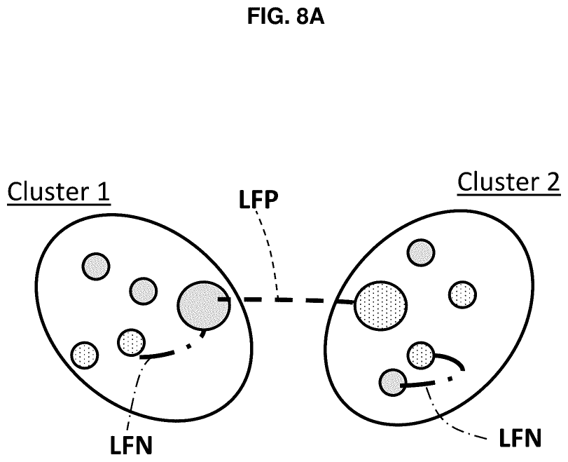

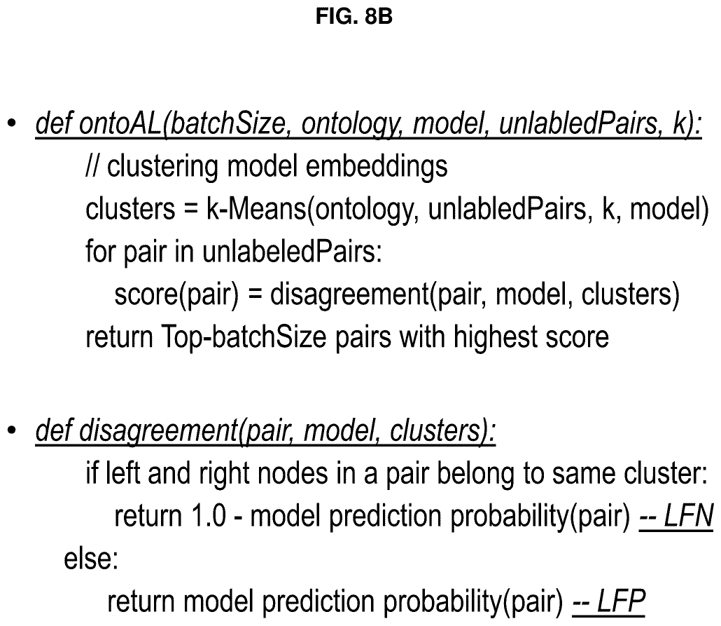

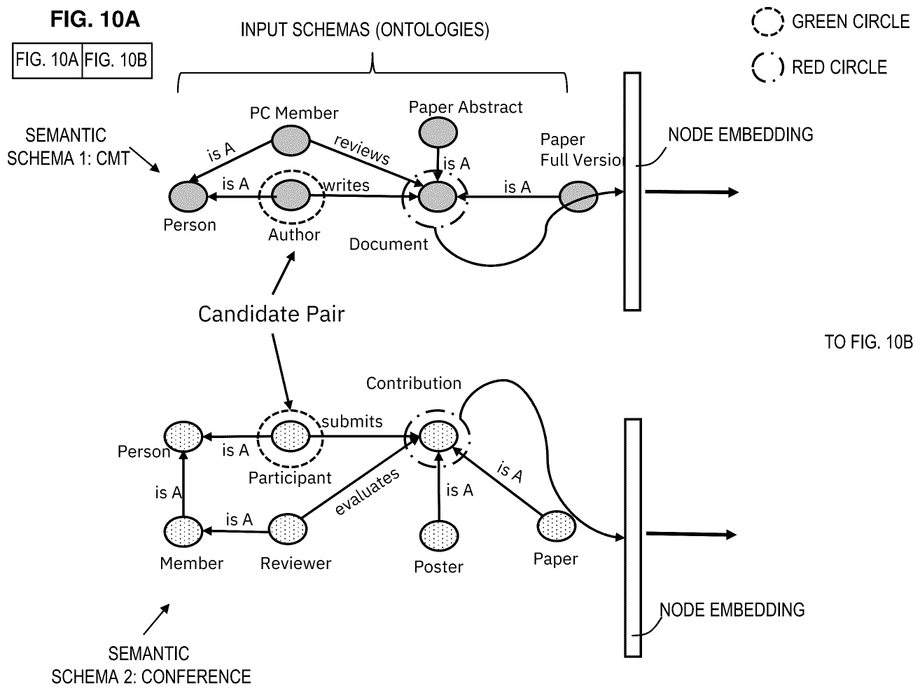

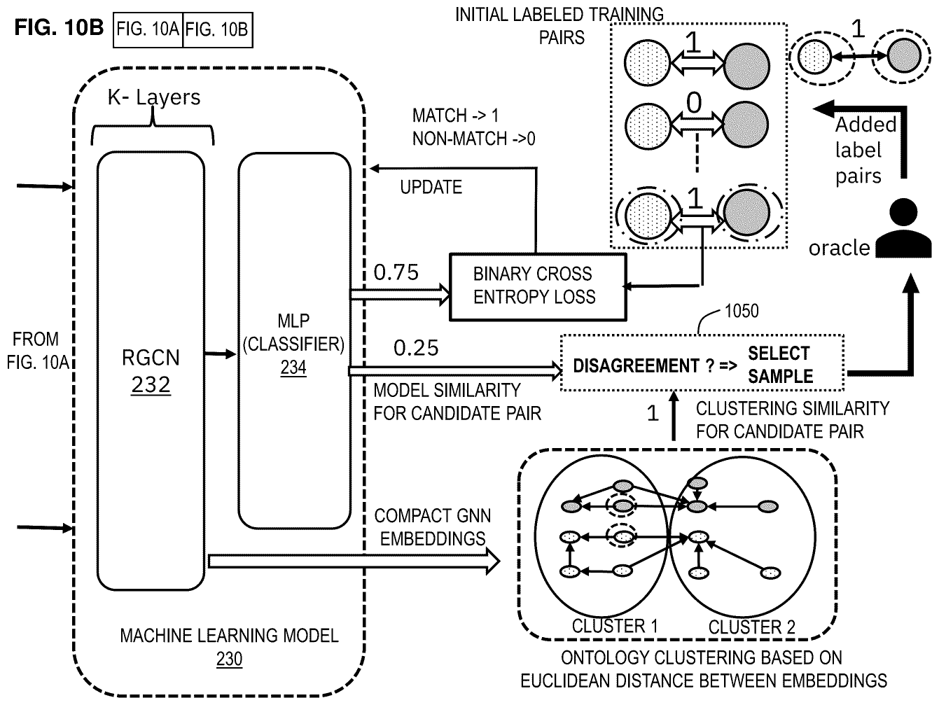

At block 312, in response to receiving the predicted labels of node/concept pairs from the machine learning model 234 and the unlabeled node/concept pairs after semantic blocking, the software code 150 is configured to cause/instruct the determination of ambiguous node pairs based on the predicted labels of node/concept pairs and based on clustering of the unlabeled node pairs (e.g., as depicted in FIG. 5). The software code 150 can include, call, and/or employ the ontology aware sample selection software 254 to determine the ambiguous node pairs. The ontology aware sample selection software 254 can instruct/call the clustering algorithm 262 to cluster the unlabeled node/concept pairs, as depicted in FIG. 8A. The clustering algorithm 262 may utilize K-means clustering that can be directly applied and uses the Euclidean distance measuring. Although not shown at this point but discussed further herein, the machine learning model 232 (RGCN) can perform compact node embedding, and the compact node embedding is provided to the machine learning model 234 for classification and to the clustering algorithm 262 for clustering, as discussed in FIG. 10B below. The compact embedding of the unlabeled node pairs by the ontology aware sample selector 254 can be 64D embedding, which means each feature vector has 64 features. In FIG. 8A, cluster 1 may be all of one type of nodes, such as the people nodes. Cluster 2 may be all another type of nodes, such as the document nodes. All the nodes in cluster 1 should be similar, just as all the nodes in cluster 2 should be similar. Although only two clusters are shown for illustration purposes, there could be many clusters (e.g., 20 clusters). The clustering is performed each iteration on the node pairs that have not been labeled.

The predicted labels of node/concept pairs from the machine learning model 234 are compared by the ontology aware sample selection software 254 to the corresponding (i.e., matching) node/concept pairs in the clusters from the clustering algorithm 262. Based on the comparison, a node/concept pair can be likely false positive (LFP) , likely False Negative (LFN), or an agreed upon match between the predicted labels from machine learning model 234 and clustering algorithm 262. As depicted in FIG. 8A, likely false positive is a pair of nodes/concepts whose nodes belong to different clusters, for example, one node in cluster 1 and the other node in cluster 2, but the same pair of nodes/concepts is classified by the machine learning model 232 as matching. Likely false negative is a pair of nodes/concepts whose nodes belong to same cluster, for example, both nodes of the pair are in cluster 1, but the same pair of nodes/concepts is classified by the machine learning model 234 (classifier) as mismatching. The disagreement is utilized as the basis to send such a node/concept pair to the human subject matter expert (SME) for labeling, as discussed in FIG. 10B below. The human labels the ambiguous node pairs and provides them to the software code 150. FIGS. 8A and 8B illustrates example operations for ontology aware sample selection. Further regarding ontology aware sample selection is discussed herein.

Referring to FIG. 3A, at block 314, in response to receiving the labeled node/concept pairs for the ambiguous node pairs from human subject matter expert, the software code 150 is configured to determine (other) unlabeled node pairs across schemas/ontologies similar to the node/concept pairs labeled by the human subject matter expert and apply the same label (e.g., match or not a match) to the other unlabeled node pairs that are similar. The software code 150 may include, call, and/or employ the ontology aware propagator software 256. The ontology aware propagator software 256 is configured to find pairs of nodes/concepts across ontologies similar to the pair of nodes/concepts labeled by the human, and then propagate the labeled pair of nodes/concepts to the machine learning model 234 (classifier) as additional training data at an adaptive rate to minimize the impact on accuracy. The machine learning model 234 (classifier) is further trained on the labeled node/concept pairs just provided by the ontology aware propagator software 256. Label propagation is performed to reduce the labeling budget including reducing the utilization computer resources and computer time as well as human labeling time, while improving the training of the machine learning model 234.

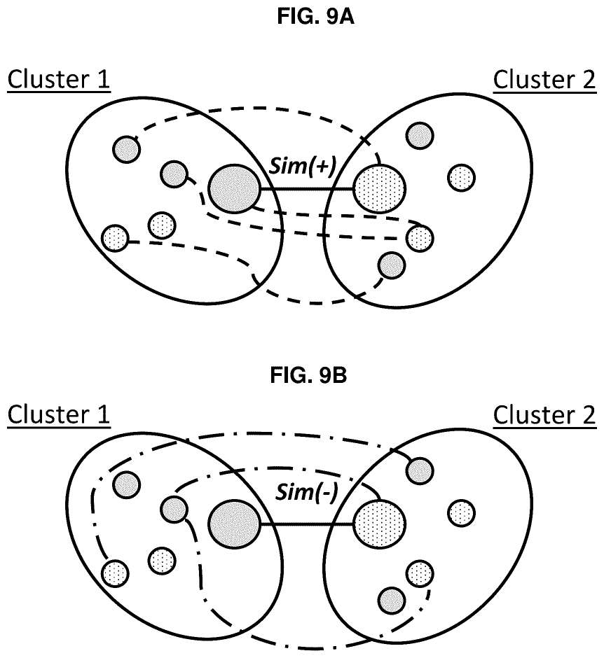

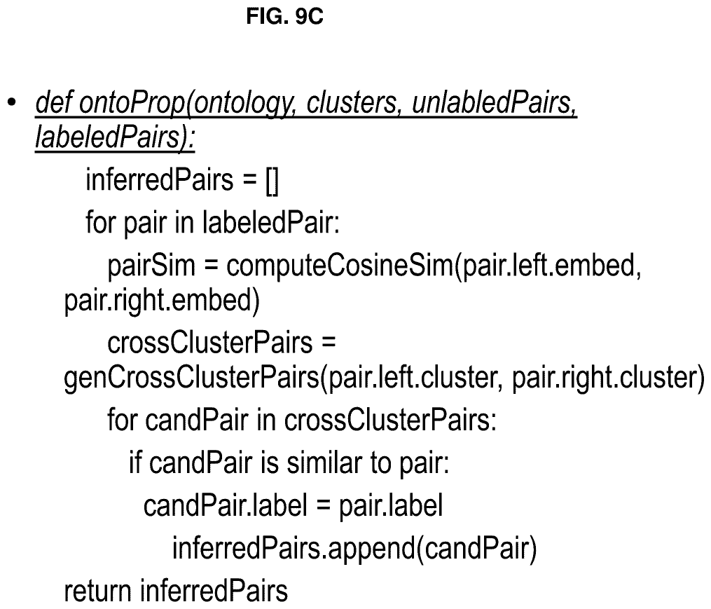

The ontology aware propagator software 256 may include, call, and/or employ the clustering algorithm 262 to perform clustering of the unlabeled pairs of nodes/concepts along with the human labeled node/concept pairs. Based on the clustering, the human labeled node/concept pairs have a similarity value with the highest value being 1 (matching) and the lowest value being 0 (non-matching). FIG. 9A depicts two clusters of nodes illustrating the cluster similarity of matching between nodes across clusters in accordance with one or more embodiments. FIG. 9B depicts two clusters of nodes illustrating cluster similarity of non-matching between nodes across clusters in accordance with one or more embodiments. FIG. 9C illustrates example operations performed by the ontology aware propagator software 256.

In FIG. 9A, cross-cluster node pairs with embedding similarity of sim(+) are labeled as matching (+), while cross-cluster node pairs with embedding similarity of sim(−) are labeled as non-matching (−). Label propagation is using the labeled pair of nodes/concept from the human and looking for cross-cluster nodes that have a similarity between the nodes greater than the similarity for the human labeled pair of nodes/concepts. For determining matching nodes when the similarity for the human labeled pair of nodes/concepts is 0.5 sim(+), the ontology aware propagator software 256 may parse and select similarities that are greater than 0.5 sim(+) in the clusters shown in FIG. 9A, and these selected pairs of nodes/concepts are then labeled as matching. For determining non-matching nodes when the similarity for the human labeled pair of nodes/concepts is 0.2 sim( ) the ontology aware propagator software 256 may parse and select similarities that are less than 0.2 sim(−) for the clusters shown in FIG. 9B, and these selected pairs of nodes/concepts are then labeled as non-matching. Boundaries and regulations can be set to propagate only the top-most pair, top least similar pairs, etc., for use as further training data for training the machine learning model 234. Also, the number of labeled pairs of nodes/concepts can adaptively vary with the increase in the number of iterations. In one or more embodiments, there may be no boundaries or regulations. Further regarding ontology aware sample propagation is discussed herein.

FIG. 3B is a flowchart of a computer-implemented method 320 for training the machine learning model 232 (e.g., RGCN) and the machine learning model 234 (e.g., classifier) according to one or more embodiments. The computer-implemented method 320 is executed by the computer 101. FIG. 3B illustrates further details of ontology aware sample selection to generate further training data for further training the machine learning model 234 according to one or more embodiments. Some blocks in FIG. 3B are analogous to blocks already discussed in FIG. 3A, and details of those blocks may be omitted. At this point, the machine learning model 234 (e.g., classifier) has been initially trained to classify/label node/concepts pairs as matching and non-matching. Accordingly, blocks 308 and 310 in FIG. 3A may not been performed as it relates to seed labels. FIG. 3B is described with reference to the block diagram depicted together in FIGS. 10A and 10B.

At block 322 of the computer-implemented method 320, the software code 150 is configured to receive two schemas/ontologies that need to be aligned. Two example schemas/ontologies are depicted in FIG. 10A. At block 324, the software code 150 is configured to perform node embedding for the two semantic schemas/ontologies, which results in a very large node embedding. In one example, the resulting very large node embedding may have 512 dimensions (D), which means that a node can be represented by a feature vector having as many as 512 features or properties. It is noted that the pairs of nodes/concepts in the large node embedding are each unlabeled. At block 326, the software code 150 is configured to perform ontology aware semantic blocking to reduce number of node/concept pairs in the large node embedding.

At block 328, the software code 150 is configured to cause the machine learning model 232 to generate compact (GNN) node embedding from the large number of node embedding provided by the known node embedding software 264. The machine learning model 232 (e.g., RGCN) can perform compact node embedding, where the compact node embedding is provided to the machine learning model 234 for classification and to the clustering algorithm 262 for clustering, as depicted in FIG. 10B. The compact embedding of the unlabeled node pairs by the ontology aware sample selector 254 can be a 64D embedding. A major difference between the initial 512-dimensional embeddings generated by the Universal Sentence Encoder (USE) and the 64-dimensional embeddings generated by Relational Graph Convolutional Network (RGCN) is that the 512-dimensional embeddings are only based on natural language. On the other hand, the 64-dimensional embeddings are ontology-aware and semantically rich. This is because RGCN is a representative graph neural network that captures the local neighborhood of the node for which the embedding is generated. RGCN not only captures the neighboring graph nodes of a given node, but it also encodes the type and directionality of the edges which connect a given node to its neighbors. Thus, being aware of both the structure and semantics of the ontology graph allows the 64-dimensional embeddings to be semantically rich in nature.

At block 330, in response to receiving the compact node embedding from the machine learning model 232, the machine learning model 234 classifies/labels the pairs of nodes/concepts having the compact node embedding as matching or non-matching while the clustering algorithm 262 clusters the pairs of nodes/concepts having the compact node embedding, as instructed by the software code 150. At block 332, the software code 150 is configured to compare the model similarity for the candidate node pair from the machine learning model 234 to the clustering similarity from the clustering algorithm 262 for the same candidate node pair to determine if the model similarity value and clustering similarity value agree or disagree. In FIG. 10B, the model similarity for the candidate pair of nodes is 0.25 while the clustering similarity for the candidate pair of nodes is 1.0. As such, values of the machine learning model 234 and the clustering algorithm 262 are determined to be in disagreement by the software code 150, because the model similarity value and clustering similarity value are not within a predetermined threshold value. If the values were interpreted as agreeing on a match or non-match for the candidate node pair, the software code 150 moves to the next candidate node pair.

Referring to FIG. 3B, at block 334, in response to the disagreement, the software code 150 is configured to determine or select the candidate node pair as an ambiguous node/concept pair to be sent to the human subject matter for labeling. At block 336, in response to receiving the human labeled node/concept pair from the human subject matter expert, the software code 150 is configured to send the human labeled node pair to the machine learning model 234 as additional training data. FIG. 10B also illustrates backpropagation as correction to modify the weights of the machine learning model 234 during training.

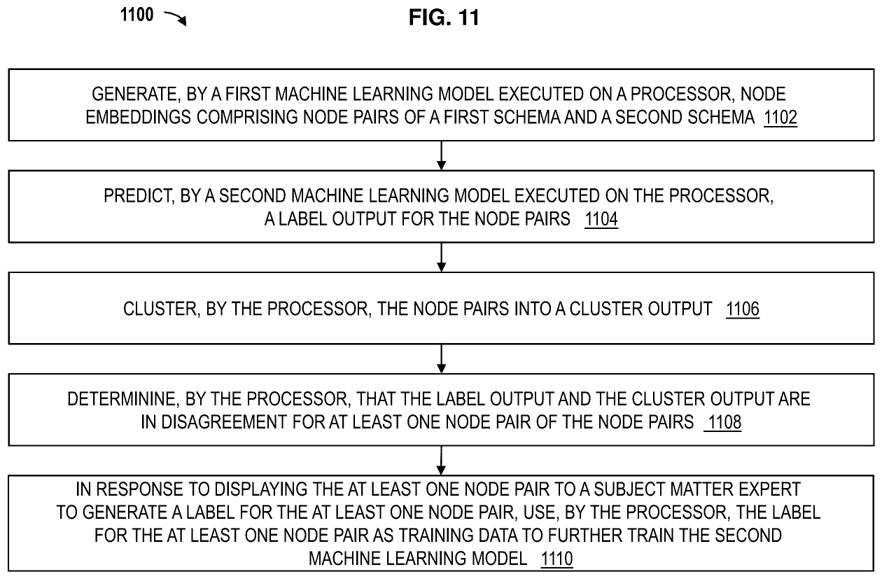

FIG. 11 is a flowchart of a computer-implemented method 1100 for active learning for graph neural network based semantic schema alignment and for training the machine learning model 232 (e.g., RGCN) and the machine learning model 234 (e.g., classifier) according to one or more embodiments. The computer-implemented method 100 can be performed by the computer 101.

At block 1102 of the computer-implemented method 1100, the software code 150 is configured to employ a first machine learning model 232 to generate compact node embeddings comprising and representing node pairs of a first schema and a second schema. FIG. 4 illustrates example semantic schema/ontology 1 and semantic schema/ontology 2. At block 1104, the software code 150 is configured to employ a second machine learning model 234 to predict a label output for the node pairs. At block 1106, the software code 150 is configured to cluster the node pairs into a cluster output. At block 1108, the software code 150 is configured to determine that the label output and the cluster output are in disagreement for at least one node pair of the node pairs. For example, the label output for a candidate node pair and the cluster output for the same candidate node pair are in disagreement as depicted in box 1050 of FIG. 10B. At block 1110, the software code 150 is configured, in response to displaying the at least one node pair to a subject matter expert (e.g., a human) to generate a label for the at least one node pair, use the label for the at least one node pair as training data to further train the second machine learning model 234, such that the machine learning model 234 improves its classification of node pairs as matching or non-matching.

According to one or more embodiments, the software code 150 is configured to determine that unlabeled node pairs of the node pairs are semantically similar to the at least one node pair, and then label the unlabeled node pairs having been determined with the label of the at least one node pair. For example, for the unlabeled node pairs that are semantically similar (e.g., using cosine similarity) to the at least one node pair. When the human label of the at least one node pair is designated as “matching”, the unlabeled node pairs having a cosine similarity greater than the cosine similarity of the at least one node pair can be utilized as training data. When the human label of the at least one node pair is designated as “non-matching” or “not matching”, the unlabeled node pairs having a cosine similarity less than the cosine similarity of the at least one node pair can be utilized as training data.

Further, the software code 150 is configured to generate/assign labeled node pairs by labeling unlabeled node pairs with the label (e.g., matching or non-matching) of the at least one node pair, in response to the unlabeled node pairs being semantically similar to the at least one node pair; the software code 150 is configured to use the labeled node pairs having the label as further training data to train the second machine learning model 234. The labeled node pairs are applied at an adaptive rate as the further training data for training the second machine learning model 234, the adaptive rate increasing with each iteration of aligning the first schema and the second schema.

Determining that the label output and the cluster output are in the disagreement for the at least one node pair of the node pair includes: comparing a model similarity score (e.g., model similarity score “0.25” in FIG. 10B) associated with the label output to a clustering similarity score (e.g., clustering similarity score “1” in FIG. 10B) associated with the cluster output for the at least one node pair, and determining that a difference in the model similarity score and the clustering similarity score is greater than a threshold. For example, the threshold could be a difference of 1, 2, 3, etc. The first machine learning model 232 includes a relational graph convolution network (RGCN). The second machine learning model 234 include a classifier, for example, an MLP classifier.

In one or more embodiments, the machine learning model 232 and the machine learning model 234 can include various engines/classifiers and/or can be implemented on a neural network. The features of the engines/classifiers can be implemented by configuring and arranging the computer system 202 to execute machine learning algorithms. In general, machine learning algorithms, in effect, extract features from received data (e.g., pairs of nodes in which one node is from a schema/ontology and another node is from another schema/ontology) in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class (or label) for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets can be utilized to train the machine learning algorithms. The training datasets can include historical data of past tickets and the corresponding options/suggestions/resolutions provided for the respective tickets. Labels of options/suggestions can be applied to respective tickets to train the machine learning algorithms, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters, and once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

Section headings and subsections may be utilized to ease understanding. It should be appreciated that the section headings, subsections, and various examples utilized herein are not meant to limit the present disclosure.

### 1. Introduction

Hybrid cloud data management experiences a paradigm shift towards the adoption of data fabric for data management agility as a top priority for businesses, organizations, and cloud service providers world-wide. Data fabric provides a semantically rich knowledge layer that helps connect different applications, processes, and data coming from heterogeneous sources. AI-enabled data integration is a step towards building such a data fabric and providing a unified view of data, making it accessible and available for large-scale data analytics, data science workflows, machine learning, and AI pipelines to derive value from this data.

Semantic schema alignment that finds matching elements across a pair of schemas based on their semantic representation forms a key step towards data integration. The semantic representation of the schema elements, often captured as an ontology, associates these elements to entities in the real world by capturing their properties and structural relationships with respect to the other elements in the schema. FIG. 7 shows an example semantic schema alignment between two schemas, which are CMT and Conference represented as ontologies. The diagonally stripped block arrows show schema alignments as matching element pairs across the two schemas, for example, Author«Participant, Document«Contribution, etc.

Earlier works on semantic schema alignment such as AML and LogMap predominantly relied on the lexical similarity between the concepts. Their capability to capture the ontology structure was limited to concept hierarchies. Graph representation learning-based techniques have been shown to be effective for semantic schema alignment as they can succinctly capture the semantic representation of the schema elements such as their properties, description, and relationships to other schema elements (not confined to hierarchies) in the form of low-dimensional vector representations. However, most Graph Neural Network (GNN)-based techniques are supervised and require a lot of labeled data to train effective models for schema alignment. Providing labeled training data entails significant manual effort from subject matter experts (SMEs), which is very expensive with respect to cost, manual labor, and computer resources. Additionally, the labeled training data needs to be diverse and representative of the underlying alignment task to train effective models. This involves SMEs to manually look at the schemas, identify matching and non-matching pairs of entities across two schemas, and provide the matching and non-matching pairs of entities as positively and negatively labeled samples for model training. The problem gets further exacerbated with an increase in the schema sizes and the number of datasets to be integrated into the data fabric.

Active learning (AL) alleviates this problem with a human-in-the-loop approach that provides labeled data incrementally and on-demand to train a model. The goal is to get the highest return in terms of model performance (i.e., model accuracy) while minimizing the amount of manual labeling effort and computer resources utilized. AL pipelines typically employ (1) sample selection techniques to choose representative and informative samples for human labeling. (2) label propagation as an optional optimization to propagate the training labels obtained from the human to other unlabeled samples which are similar to the labeled samples, and (3) blocking also as an optional optimization to prune away non-ambiguous samples of data and scale the process of sample selection to large datasets. Existing sample selection techniques such as entropy based sample selection, for example, Query-by-Committee (QBC), mostly rely on model performance to drive sample selection. Importance weighted sampling selects samples that minimize the sampling bias and are representative of the true underlying data distribution. Other techniques such as gradient and error-based sample selection are computationally expensive and hence fail to scale to large datasets while maintaining interactive sample selection times. There also exist graph-aware sample selection techniques for link prediction between two graph nodes. These graph aware techniques mostly rely on aggregating structural properties such as degree and centrality sum. However, they do not exploit the semantics of the relationships between the nodes in the graph for sample selection. Similar to sample selection, label propagation and blocking techniques are either model dependent or use string similarity heuristics, which are devoid of any meaningful semantics capable of relating schema elements to real-world entities and relationships.

In accordance with one or more embodiments of the present disclosure, a novel active learning framework (ALFA) is provided to address the aforementioned limitations of existing AL techniques for semantic schema alignment. According to at least one aspect. ALFA is configured to exploit the rich semantic information from the underlying schemas to drive the process of AL. One or more embodiments use GNNs such as, for example, the machine learning model (RGCN) 232 to capture the semantic representation of the elements that includes properties such as names, which are descriptions as well as relationships with other elements in the schema. One or more embodiments provide a novel ontology aware sample selection algorithm, which may be implemented in the ontology aware sample selection software 254, to minimize human labeling cost by choosing samples of schema elements across a pair of schemas based on their likelihood of being misclassified by the GNN model (e.g., by the machine learning model 234 working in conjunction with the machine learning model 232). To further reduce human effort in labeling training data, a novel ontology aware label propagation algorithm, which may be implemented in the ontology aware label propagator software 256, has been developed that utilizes human-labeled schema element pairs and propagates their labels to semantically similar pairs of schema elements, according to one or more embodiments. Further, to scale ALFA to large schemas and to handle the issue of class imbalance (label skew) in the labeled training data, one or more embodiments provide a semantic blocking technique, which may be implemented in the ontology aware semantic blocking software 252, to prune away pairs of schema elements that are unlikely matches based on their semantic representation. ALFA is the first to address the problem of AL for GNN-based semantic schema alignment where schemas are represented as ontologies.

The present disclosure includes an extensive evaluation of the novel techniques on three real-world datasets against several state-of-the-art baselines. Particularly, the discussion compares ALFA against AL baselines for GNN-based schema alignment. One state-of-the-art GNN-based schema alignment model and several AL baselines have been chosen for the experimental evaluation. The experimental results on three real-world datasets show that (1) ALFA leads to a substantial reduction (e.g., 27% to 82%) in the cost of human labeling. (2) semantic blocking reduces label skew up to semantic blocking reduces label skew up to 40 times without adversely affecting model quality and scales AL to large datasets, and (3) sample selection achieves comparable schema matching quality (e.g., 90% F1-score) to models trained on the entire set of available training data. ALFA has outperformed the state-of-the-art ontology alignment system, BERTMap, in terms of (1) 10 times shorter time per AL iteration (thereby reducing computer resources such as a reductions in the utilization of processors, registers, cache memory, RAM, bandwidth, etc.) and (2) requiring half of the AL iterations to achieve the highest convergent F1-score. It should be appreciated that one or more embodiments provide (i) an end-to-end active learning framework for GNN based semantic schema alignment, (ii) a novel ontology-aware sample selection algorithm for human labeling that exploits the semantic representation of the schema elements to minimize human labeling cost including computer resources, (iii) an efficient ontology aware label propagation algorithm that propagates labels based on their semantic representation to further reduce the cost of labeling training data, and (iv) an effective semantic blocking algorithm that prunes likely mismatches between schema elements to scale to larger schemas, thereby reducing the sample selection latency without sacrificing the model quality.

### 2. Preliminaries and System Overview

In this section, a GNN-based supervised model for schema alignment is described where the schemas are represented as ontologies. Also, the basic active learning techniques and terminologies are described followed by the system overview for ALFA according to one or more embodiments.

FIG. 12 depicts the architecture of a GNN-based semantic schema alignment model to find matching elements across two input schemas. FIG. 12 utilizes a GNN to generate a low-dimensional representation (embeddings) for each node (schema element) in the two input schemas. The system then uses a classifier such as a multilayer perceptron (MLP) with a sigmoid output layer to classify a given pair of elements (e.g., node pairs) across the two input schemas (e.g., ontologies) as a match or non-match. The GNN-based semantic schema alignment model takes the two ontology graphs representing the schemas to be matched, a set of initial feature vectors (embeddings) for each schema element (concept) in the ontology graph, and a training set of labeled matching and non-matching ontology concept pairs as input. The initial set of feature vectors is typically generated from the schema element properties such as their label names and descriptions using a pre-trained language model.

The GNN model takes the schema element properties as well as their structure (relationships with other schema elements) into account while generating a semantically rich representation of each schema element. The alignment model also distinguishes between the different kinds of relationships among the schema elements such as “is-A” or hierarchical relationships, unions, and other functional relationships such as “writes” and “reviews” as shown in FIG. 7. Training such a GNN-based schema alignment model in a supervised manner requires a large amount of labeled training data consisting of matching and non-matching pairs of schema elements. During the training process, the losses based on the classification labels are back-propagated to learn the appropriate node embeddings of the schema graphs. During the prediction phase, the model generates the compact embeddings and uses them as input to the classifier to identify matching or non-matching pairs of schema elements. Active Learning (AL) can significantly reduce the amount of labeled data required to train such models, in accordance with one or more embodiments.

### 2.2 Generic Active Learning (AL) Framework

A general AL framework enables an iterative human-in-the-loop process where a model is iteratively trained on data labeled by a human or oracle at a given cost. The iterative training process stops when the desired matching quality of the model is achieved and/or when the labeling budget is exhausted. Some components of an AL framework are described briefly below. It is noted that sample selection is a required component in an AL framework whereas label propagation and blocking are optimization techniques that can be optionally deployed.

### 2.2.1 Sample Selection

In a typical active learning framework lies a smart sample selection technique that chooses informative samples from the underlying data distribution for the human (or oracle) labeling in each AL iteration. In accordance with one or more embodiments, the target is to learn an effective model with the minimum amount of labeled training data in the fewest possible AL iterations. This is achieved by choosing samples that influence the model based on one or more factors such as their representativeness of the underlying data distribution, associated uncertainty of model prediction, expected effect on model learning, etc., according to one or more embodiments.

### 2.2.2 Label Propagation

To further optimize the return on investment and to reduce the cost of human labeling, label propagation can be used to propagate the training labels obtained from the human (or oracle) in each AL iteration to other unlabeled training data based on the similarity of the unlabeled data to the human-labeled data. A variety of different techniques and similarity metrics can be used for label propagation based on the type of training data being used and the model being trained. The choice of this metric and its effective implementation affect the quality of label propagation and hence have a direct bearing on the performance of the model being trained. Label propagation is alternatively termed as mapping extension, weak supervision, and label spreading in the state-of-the-art.

### 2.2.3 Blocking

Unlike sample selection and label propagation, which are applied in each AL iteration, blocking is a pruning step that is typically applied once before commencing active learning. To scale the process of sample selection to large datasets, blocking techniques are used to prune away (i.e., remove) obvious non-ambiguous samples from the majority class that is typically the non-matching (or the negative label) class. This results in a reduced search space of candidate samples depending on the level of aggression with which blocking is applied. Additionally, blocking is also used to control the class imbalance (or label skew) to train effective models efficiently. Blocking helps achieve interactive sample selection times over large datasets, making the AL pipeline suitable for the inclusion of a human-in-the-loop to perform the labeling task. On the other hand, blocking is also prone to pruning away the ambiguous samples from the minority class (i.e., the positive label class containing all the matching pairs) which could have benefited from human labeling. The trade-off thus is between scalability and the desired classification quality of the model.

### 2.3 ALFA System Overview

According to one or more embodiments, given a pair of semantic schemas (which can also be referred to as ontologies) O_{L} and O_{R}, a human oracle H, a supervised GNN-based semantic schema alignment model M, and a labeling budget B, an active learning framework (ALFA) has been designed that queries H for the minimum number of informative training labels L such that |L|≤B and the re-trained version of M predicts the equivalent schema element pairs across O_{L} and O_{R} with a high accuracy.

FIG. 5 depicts the architecture of ALFA that exploits the rich semantic information of the underlying schemas represented as ontologies combined with model confidence for smart sample selection, label propagation, and blocking in accordance with one or more embodiments. Collectively, the sample selection, label propagation, and blocking ensure effective use of the labeling budget (and computer resources) by learning a high-quality schema alignment model in fewer AL iterations, according to one or more embodiments. Each active learning iteration is the process of proceeding through an active learning pipeline for training a model (e.g., classifier). Using a given two ontologies, there can be many iterations to train the machine learning model 234 to align the given two ontologies. One or more embodiments are configured to train the machine learning model 234 to accurately classify node/concept pairs as matching or non-matching for the two ontologies, thereby aligning the two ontologies. In one or more embodiments, the software code 150 can combine the two ontologies based on the node pairs classified as matching by the machine learning model 234, resulting in a large ontology that can be utilized by a natural language processor (NLP) to receive inquiries and answer questions.

ALFA consumes an ontology pair (e.g., as depicted in FIGS. 4 and 5) to be matched and generates the Cartesian Product of all possible schema element (concept) pairs as the pool of unlabeled examples, which can be quite extensive for large ontologies. A semantic blocking algorithm (as depicted in FIG. 5) prunes the obvious non-matches to reduce the search space for sample selection and class imbalance. A small seed set, typically 0.1%-0.3% of the post-blocking pairs, is manually labeled (with the assistance of automatic labeling heuristics or labeling functions if necessary) and fed to a learner to train an initial GNN-based schema alignment model. The actual sizes of the seed label sets may be between 5 and 40 across all the experimental datasets.

This bootstrapping operation is utilized because one or more embodiments use a supervised GNN model that is to be initialized before applying AL. In each AL iteration, an ontology aware sample selector (e.g., ontology aware sample selection software 254) combines the rich semantic information from the input schemas with the model output to choose a batch of ambiguous samples for human labeling. The batch size is set based on the number (#) of labels the human oracle prefers to label (e.g., a predefined number) per AL iteration and the maximum (#) of iterations possible with a pre-constrained labeling budget. To further reduce the human labeling effort and reduce the utilization of computer resources, ontology aware label propagation (e.g., ontology aware propagator software 256) has been designed, which identifies node/concept pairs that are semantically similar to the node/concept pairs labeled by the human and infers the labels for such node/concept pairs. The node/concept pairs labeled by the human and the node/concept pairs whose labels are inferred through label propagation are together included as additional training data into the existing training set. The model (e.g., machine learning model 234) is re-trained on the cumulative set of labeled node/concept pairs at the end of each AL iteration.

### 3 ALFA System Design

In this section, one or more embodiments describe the main building blocks of ALFA. The core components include the ontology aware sample selection (e.g., ontology aware sample selection software 254), followed by the optimizations such as the ontology aware label propagation (e.g., ontology aware propagator software 256) and ontology aware semantic blocking (e.g., ontology aware semantic blocking software 252).

### 3.1 Ontology Aware Sample Selection

The ontology aware sample selection algorithm chooses ambiguous samples, which are pairs of schema elements that are likely to be misclassified, (i.e., a matching node pair being mis-predicted as a non-matching node pair, or a non-matching node pair being mis-predicted as a matching node pair) and passes them for human labeling. According to one or more embodiments, the likely mis-predictions are detected based on the labeling disagreement between the trained model (e.g., machine learning model 234) and an ontology clustering algorithm (e.g., clustering algorithm 262) that clusters the schema elements (ontology concept nodes) in the unified ontology graph.

The unified ontology graph combines both of the input ontologies into a single graph. It is noted that both the model (e.g., machine learning model 234) and the clustering algorithm (e.g., clustering algorithm 262) are iteratively updated, thereby resulting in the detection of an updated set of ambiguous samples in each AL iteration. The sample selector does not explicitly control the class skew or the ratio of matching and non-matching pairs in each AL iteration. The class imbalance issue is resolved by the semantic blocking optimization (details are in Section 3.3), which is applied before AL commences. However, it was empirically observed that the ambiguous samples included concept pairs from both the classes (i.e., matching and non-matching) over several AL iterations.

FIGS. 10A and 10B depict the ontology aware sample selection according to one or more embodiments. FIGS. 10A and 10B include a representative relational graph convolutional network (RGCN) (e.g., machine learning model 232) that captures both type and direction of an edge into a node's local neighborhood during the node embedding generation (i.e., generating compact feature vectors) and has improvements over regular GCNs for link prediction on knowledge graphs, according to one or more embodiments. Therefore, embodiments use the RGCN as the GNN model that is trained over several active learning iterations. In each active learning iteration, the model (e.g., machine learning model 230 that includes the RGCN and the MLP classifier) is trained using the current set of labeled training node pairs. The binary cross entropy loss (depicted in FIG. 10B) computed at the output of the multilayer perceptron (MLP) classifier (e.g., machine learning model 234) based on the model output and the ground truth provided by the labeled training pairs is backpropagated to update the model. For example, the machine learning model 234 is updated. Also, the machine learning model 232 is updated by the same binary cross entropy loss depicted in FIG. 10B. This is because models 232 and 234 are stacked on the top of each other. This allows the loss to update not only the weights of the multi-layer perceptron, but also the weights of the RGCN. The compact node embeddings (i.e., feature vectors) produced by the RGCN model in each AL iteration are fed to (1) an MLP classifier (e.g., machine learning model 234) that can predict the labels of the remaining unlabeled node pairs and (2) a K-Means clustering algorithm (e.g., clustering algorithm 262) that clusters the distinct ontology concept nodes corresponding to the remaining set of unlabeled node pairs, based on the Euclidean distance between their embeddings (feature vectors).

Each candidate unlabeled node pair, in green dashed circles shown in FIG. 10A, is scored using (1) the RGCN model plus MLP classifier and (2) the clustering model (e.g., clustering algorithm 262). If both the ontology nodes/concepts in the candidate pair lie in the same cluster, these ontology concepts (i.e., pair of nodes) are likely to represent the same semantic node/concept and hence can be considered a match; however, if the RGCN plus MLP based alignment model predicts the same pair as a non-match for the same pair of nodes, there is a disagreement implying a likelihood of misclassification, namely Likely False Negative (LFN). Similarly, if a pair of concepts lies across two clusters, the pair of concepts likely represent different semantic nodes/concepts according to the clustering algorithm; if the RGCN plus MLP based alignment model predicts the same node pair as a match, there is a disagreement implying a likelihood of misclassification, namely Likely False Positive (LFP). The disagreement between the classification model (e.g., machine learning model 234) and the clustering model (e.g., clustering algorithm 262) in essence quantifies the ambiguity, which makes the node pair an ideal candidate for human labeling.

Algorithm 1 in FIG. 13A shows the details of the ontology aware sample selection algorithm (e.g., ontology aware sample selection software 254) in each AL iteration. The ontology aware sample selection algorithm takes as input (1) the two ontologies (Ont_{L} and Ont_{R}) representing the schemas, (2) the remaining pool of unlabeled candidate pairs of nodes across the two ontologies, P_{remaining}, to choose the samples from, (3) the batchSize indicating the number of samples required to be selected for labeling in an AL iteration, (4) a reference to the GNN-based alignment model, and (5) the number of clusters n_{cluster} for ontology clustering. In FIG. 13A, line 1 of Algorithm 1 creates a set of input nodes from two input ontologies; line 2 computes the ontology clusters based on the RGCN model embeddings using K-Means clustering, and the ontology clusters are updated in each AL iteration. Since K-Means clustering is applied on the RGCN model embeddings, it derives clusters by applying the Euclidean distance metric on the 64-dimensional RGCN model embeddings. All the concepts whose embeddings are closer and have a short Euclidean distance amongst themselves fall into the same cluster. Since the embeddings are updated in each active learning iteration, the ontology clusters are also updated. It is also noted that K-Means clustering is applied on the concepts (nodes in the ontology graph) belonging to P_{remaining}, which is the set of remaining pool of unlabeled candidate pairs. The set P_{remaining} keeps shrinking in each active learning iteration, as the pairs are drawn out of this set for labeling by the oracle in each iteration. Since ontology clusters are created upon the nodes belonging to P_{remaining} in each iteration, as this set P_{remaining} keeps shrinking, the clusters also evolve in each iteration. The cluster sizes generally tend to get smaller as the system progresses toward the later active learning iterations. In FIG. 13A, lines 4-10 of the Algorithm 1 compute the disagreement score for each remaining pair based on the RGCN-based schema alignment model prediction probability, PredProb. If the nodes in a given pair belong to the same ontology cluster (indicating a match as per the ontology clustering), then (1.0—model prediction probability) reflects the quantum/amount of disagreement. A high model prediction probability indicates a predicted match while a low model prediction probability indicates a predicted non-match. Similarly, if the nodes belong to different clusters (indicating a mismatch as per the ontology clustering), the model prediction probability provides the disagreement score. Finally, in lines 11-12, the Algorithm 1 sorts all the unlabeled node pairs based on the disagreement score in a descending order and chooses the top-k pairs for human labeling. In line 13, the Algorithm 1 also returns the generated clusters along with the top-k pairs that are used as input by the label propagation algorithm.

It is noted that both ontology clustering (e.g., by clustering algorithm 262) and model prediction (e.g., by machine learning models 234) are based on the RGCN model embeddings (e.g., feature vectors). Therefore, the model quality and the cluster quality improve with more AL iterations as the RGCN model embeddings are refined. Given that clustering is iteratively applied on model embeddings corresponding to nodes/concepts belonging to the remaining unlabeled node pairs, the produced clusters are non-homogeneous and large in the initial AL iterations and shrink in the later iterations as the remaining unlabeled pairs become fewer. Another insight here is that each method tries to capture the real underlying data distribution differently. While the ontology clustering (e.g., clustering algorithm 262) uses the Euclidean distance between the node embeddings as the similarity metric to form clusters of similar nodes, the schema alignment model uses a trained neural network (e.g., machine learning model 234), i.e., a multilayer perceptron (MLP) with a sigmoid output layer to determine the similarity between two embeddings (e.g., feature vectors). Hence, a labeling disagreement between the ontology clustering and the neural network is to capture the ambiguity in modeling the actual distribution which makes the node pair a candidate for human labeling.

Although the disagreement computation has similarities to entropy or variance computation in QBC, it is worth noting that embodiments do not use a committee of several supervised learning models of the same kind as in QBC. Instead, the committee in one or more embodiments includes an unsupervised clustering algorithm 262 and a supervised GNN model (e.g., the machine learning model 232 with machine learning model 234). Clustering employs the Euclidean distance metric that gives each dimension in the GNN-generated embeddings equal weightage. On the other hand, the MLP is data-driven and learns the appropriate weight for each dimension based on the embeddings and their expected labels. This ensures that both models (e.g., the clustering algorithm 262 and the machine learning model 234) capture different signals for ontology alignment which makes ALFA's disagreement computation novel and more informative than that of QBC, along with being less computer resource intensive (e.g., uses fewer computer resources).

### 3.2 Ontology Aware Label Propagation

To further reduce human effort in labeling training data and to use fewer computer resources, one or more embodiments provide a novel ontology aware label propagation algorithm (e.g., ontology aware propagator software 256) that utilizes the schema element (node) pairs labeled by the human and propagates their labels to semantically similar pairs of schema elements across the two input ontologies.

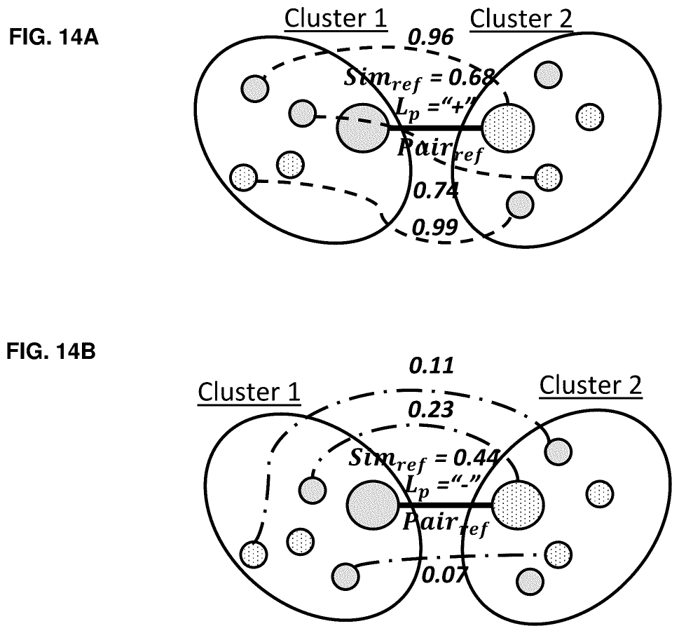

FIGS. 14A and 14B depict how to propagate the label L_{P} assigned by a human for a specific pair Pair_{ref} to several other unlabeled samples (concept pairs) according to one or more embodiments. This is done by selecting the unlabeled pairs U which are semantically most similar to Pair_{ref} and then borrowing the same label L_{P}. For each pair Pair_{ref} (of nodes across the two ontologies) labeled by a human, the ontology aware label propagation algorithm first computes the cosine similarity, Sim_{ref}, between the embeddings (e.g., feature vectors) of the nodes (Pair_{ref.left}, Pair_{ref.right}) within that node pair. The ontology aware label propagation algorithm then identifies the clusters that each node in the pair Pair_{ref} belongs to, in order to find other nodes that are similar to the nodes in Pair_{ref}. The ontology aware label propagation algorithm then computes the Cartesian product of all possible pairs of nodes across the two identified node clusters that belong to two different ontologies provided as input.

It is noted that if both the nodes in the pair belong to the same cluster, the ontology aware label propagation algorithm chooses Cartesian product of all possible cross-ontology pairs within the same cluster. The ontology aware label propagation algorithm marks these as the pool of candidate pairs for label propagation. Further, one or more embodiments are configured to handle the propagation of matching (+) and non-matching (−) labels provided by the human to Pair_{ref} as two separate cases.

Case 1: matching pair. This case handles the propagation of a matching label L_{P} assigned by a human to Pair_{ref}. All pairs within the pool of candidate pairs, whose cosine similarity between the node embeddings exceeds Sim_{ref}, are assigned the matching label L_{P}. The example in FIG. 14A shows Pair_{ref} as the two nodes across Clusters 1 and 2 connected with a solid green line. The qualifying pairs, whose node embedding similarity exceeds Sim_{ref} (0.68), are shown connected with dashed green edges. In accordance with one or more embodiments the perception is that if a human labels a node pair as a match, then the candidate pairs similar to the labeled pair (having their nodes belonging to the same clusters as the ones in Pair_{ref}) and whose constituent node similarity is greater than that of the labeled pair could borrow the same label.

Case 2: non-matching pair. This case handles the propagation of a non-matching label LP assigned by a human to Pair_{ref}. All pairs within the pool of candidate pairs whose cosine similarity between the node embeddings is below Sim_{ref}, are assigned a non-matching label L_{P}. Symmetrically, FIG. 14B shows Pair_{ref} as the two nodes across cluster 1 and 2 connected with a solid red line that is labeled as a non-match by the human. The pairs connected by the red dashed lines (e.g., long dashes and a dot) having their node embedding similarity below Sim_{ref} (0.44) borrow the negative label from Pair_{ref}.

Having determined the methodology for label propagation, the next step is to determine the quantum of label propagation in each AL iteration that would be sufficient to achieve the intended reduction in human labeling effort while also maintaining the desired level of accuracy. ALFA therefore provides a flexible mechanism to control the trade-off between the reduction in human labeling cost and model quality (F1-score) using three different modes of propagation.

Mode 1: unrestricted. In this mode of label propagation, the human-provided label for each reference pair, Pair_{ref}, is propagated without any restrictions to all eligible concept pairs based on the method described in cases 1 and 2 above. This is the most aggressive form of label propagation and provides the maximum amount of reduction in human labeling effort at the cost of achieving a lower model quality.

Mode 2: conservative. In this mode, the human provided label for Pair_{ref} is propagated more conservatively to a fixed number, top-k pairs, which have the highest semantic similarity to Pair_{ref}. For instance, k could be 1, in which case, the label will be propagated to one additional unlabeled pair which is semantically the most similar to the pair labeled by the human. This mode allows for the most fine-grained control over the amount of label propagation and the value of k could be chosen as a predetermined value to suit the available human labeling budget. Note that embodiments set k to 1 in the experiments for conservative mode. This is because the label propagation happens for each reference node pair labeled by the oracle/human, in other words, if 20 pairs of nodes are labeled by the human/oracle in an AL iteration, conservative mode infers the labels for 20 more node pairs. Propagating to top-3 or top-5 pairs results in 3 times to 5 times more labels in each AL iteration which was empirically found to be aggressive in nature.

Mode 3: adaptive. This mode allows for propagating a human-provided label adaptively to a varying number of unlabeled samples in each AL iteration. The key idea is that label propagation is dependent on the quality of clustering which is done based on the model-generated embeddings (e.g., feature vectors). In the initial AL iterations, the model (e.g., machine learning model 234) is still not mature and hence label propagation is done less aggressively to avoid sacrificing accuracy by incorrect label propagation. As the model (e.g., machine learning model 234) becomes more accurate, the clustering is also more refined and hence the labels are propagated more aggressively without sacrificing on model accuracy. In the current example implementation, one or more embodiments can propagate the label of Pair_{ref} to top-k pairs that have the highest similarity to Pair_{ref} but with an additional constraint that k is chosen to be the numerical value of the current AL iteration. The flow of an AL iteration is clearly explained in FIG. 13F. Each AL iteration starts when the system has a new set of training examples (also called training samples) which are labeled by the oracle. The Algorithm 6 first re-trains the RGCN model on the entire set of cumulative training samples we have seen so far (Line 6 in Algorithm 6 in FIG. 13F). Then, Algorithm 6 performs ontology-aware sample selection and ontology-aware label propagation in lines 7 and 8 of the algorithm to get labeled pairs (Pₛₑₗ and Pₚᵣₒₚ). Subsequently, Algorithm 6 removes the union of the sets of labeled pairs (Pₛₑₗ U Pₚᵣₒₚ) from the unlabeled set P_{remaining} in line 10. Finally, Algorithm 6 adds these labeled sets into the cumulative training set Pₜᵣₐᵢₙ that are present so far in line 11. Next, Algorithm 6 evaluates the current version of the model that has been re-trained at the beginning of the AL iteration on a test set Pₜₑₛₜ in line 12. This evaluation step is optional and may be skipped in real-world deployments of ALFA depending on the availability of the test set. This is where each active learning iteration ends. Hence, the adaptive mode can be considered as a variant of the conservative mode with a dynamically changing value of k that reflects the increasing confidence in the model as it is refined for each AL iteration. The mode 3 adaptively balances the trade-off between the cost of human labeling and model accuracy.

The present disclosure provides a detailed empirical evaluation of the above mentioned trade-off for these modes (modes 1, 2, and 3) of label propagation in Section 4.3. By default, one or more embodiments use the conservative mode of label propagation in the end-to-end evaluation of ALFA. The discussion below is how to choose the label propagation mode.

Algorithm 2 in FIG. 13B describes an aspect of the novel ontology aware label propagation algorithm (e.g., ontology aware propagator software 256) according to one or more embodiments. In FIG. 13B, the Algorithm 2 takes as input a set of remaining unlabeled node pairs (P_{remaining}), a set of human labeled node pairs in the current AL iteration (P_{labeled}), the clusters output by the ontology clustering algorithm, the label propagation mode labelPropMode, and the numerical value of the current AL iteration, iter. In Algorithm 2 in FIG. 13B, lines 2 to 15 iterate over each labeled node pair, Pair_{ref}, and compute the set of node pairs, P_{inferred}, to which the label of Pair_{ref} is propagated. In Algorithm 2 in FIG. 13B, lines 6 to 12 determine which node pairs among the candidate node pairs, candPairs, need to be shortlisted in each AL iteration as P_{shortlisted} for inclusion into the final set of node pairs, P_{inferred}, with propagated labels. If the mode of label propagation is “unrestricted”, all the candidate node pairs are shortlisted (line 7). In the case of the “conservative” mode, the top-k pairs (where k=1) among the candidate node pairs with the highest similarity to Pair_{ref} are shortlisted (line 8). If the mode is “adaptive”, k is set to the numerical value of the AL iteration, iter, and the top-k node pairs are shortlisted (line 9). In FIG. 13B, line 13 indicates that each node pair among the set of shortlisted node pairs, P_{shortlisted}, gets the same label as Pref. Line 14 includes P_{shortlisted} into the set of node pairs with propagated labels, P_{inferred} which is returned in line 16 of Algorithm 2 in FIG. 13B.

Algorithm 3 (e.g., ontology aware propagator software 256) in FIG. 13C describes how to generate the candidate pool of unlabeled node pairs for each reference pair, Pair_{ref}, according to one or more embodiments. In FIG. 13C, the Algorithm 3 takes Pair_{ref} and the cluster belongingness of the left and right nodes within Pair_{ref} as input parameters. As mentioned before, it is possible that the left and right clusters are the same. In FIG. 13C, the Algorithm 3 enumerates each candidate pair, Pair_{cand}, across the clusters and checks if the left and right nodes within Pair_{cand} belong to different ontologies (line 6). For each cross-ontology pair, Algorithm 3 handles the propagation of the matching and non-matching labels separately in line 8 based on the embedding similarities, Sim_{ref} and Sim_{cand}, computed in lines 2 and 7 respectively. In FIG. 13C, the Algorithm 3 includes Pair_{cand} into the set of candidate node pairs candPairs in line 9 only if the criteria are met for Case 1: matching node pair and Case 2: non-matching node pair as described earlier. Finally, the set of candidate node pairs is returned in line 14 of Algorithm 3.

### 3.3 Semantic Blocking

One or more embodiments provide a semantic blocking technique (e.g., ontology aware semantic blocking software 252) that prunes away pairs of schema elements that are unlikely matches based on their semantic representation. This reduces the search space of sample selection thereby allowing ALFA to scale to larger schemas. Additionally, embodiments also reduce label class imbalance between the matching and non-matching pairs thus enabling the training of more accurate alignment models efficiently.

Existing techniques for blocking such as those based on the Jaccard similarity metric are dependent on pure string matching and are unable to fully capture the semantic similarity of the schema elements. As a result, this may lead to a lot of false negatives, namely pruning away a number of matching pairs thereby adversely affecting model accuracy. To overcome this limitation, one or more embodiments provide an unsupervised semantic blocking technique (e.g., ontology aware semantic blocking software 252) that prunes the obvious non-matching schema elements based on their semantic representation to reduce the number of false negatives.

One or more embodiments can first preprocess the labels and the textual description (if available) of the schema elements. The textual description of the schema elements is tokenized using a word tokenizer, for example, the Natural Language Toolkit (NLTK). Software (e.g., ontology aware semantic blocking software 252) removes the stop-words, special characters such as punctuation and arithmetic symbols from the tokens. Software (e.g., ontology aware semantic blocking software 252) concatenates the preprocessed label and description tokens separated by a whitespace as the separator and feed the resulting text into a pre-trained language model (e.g., Universal Sentence Encoder (USE). The obtained low-dimensional vectors are as the semantic representations of schema elements.

In this section, two variants of USE based semantic blocking are discussed, which are compared against Jaccard-based and BERT-based blocking baselines below. BERT-based blocking has been evaluated as a deep learning-based blocking candidate for entity matching and recently used by a state-of-the-art ontology alignment system called BERTMap.

USESim. In this variant, the software computes the cosine similarity sim_{USE} between the USE embeddings of the schema elements in each concept pair. If sim_{USE} is lower than a predetermined similarity threshold parameter τₛᵢₘ, the pair is pruned away. Despite parallelizing USESim, it has latency as it enumerates the entire search space of all possible pairs in the Cartesian product. Accordingly, one or more embodiments can use an efficient blocking variant called USECluster.

USECluster. The schema elements in the two input schemas are clustered based on the Euclidean distance between these embeddings. The number of clusters is a parameter that allows the system to achieve a prespecified target level of blocking in terms of number of post-blocking pairs. The semantic blocking algorithm prunes away all the schema element pairs where the individual elements in the node pair lie across different clusters indicating a semantic mismatch.

Algorithm 4 in FIG. 13D describes the USESim variant of semantic blocking (e.g., ontology aware semantic blocking software 252) which takes as input the two ontologies representing the schemas Ont_{L}, Ont_{R}, and the similarity threshold τₛᵢₘ. In Algorithm 4 in FIG. 13D, lines 3 to 9 enumerate the entire search space of Cartesian Product between the left and right ontologies, Ont_{L} and Ont_{R}. For each candidate pair, P_{cand}, the USE embedding similarity value, Sim_{USE}, between the constituent nodes is computed in line 5 and is compared against τₛᵢₘ in line 6. Line 7 adds the candidate pair Pair_{cand} to the set of post-blocking pairs if it qualifies in Algorithm 4 in FIG. 13D. Finally, line 10 returns the set of post-blocking pairs, P_{remaining}.

Algorithm 5 in FIG. 13E describes the USECluster variant of semantic blocking (e.g., ontology aware semantic blocking software 252) that takes as input the two ontologies representing the schemas Ont_{L}, Ont_{R}, and the number of blocking clusters, blocking_{cluster}. In line 2 of FIG. 13E, the Algorithm 5 uses K-Means clustering to cluster the schema elements based on their semantic representation captured by the language model (USE) embeddings. In the Algorithm 5, lines 3 to 7 enumerate the clusters. The set of cross-ontology schema element (node) pairs within each cluster (Pair sᵢ) is computed in line 5 and is added to the set of post-blocking pairs, P_{remaining} in line 6. Finally, the set of post-blocking pairs, P_{remaining}, is returned in line 7 in the Algorithm 5 of FIG. 13E.

### 3.4 Putting It All Together

Algorithm 6 in FIG. 13F provides a description of ALFA's overall functionality and evaluation in terms of the ontology aware sample selection (e.g., ontology aware sample selection 254), ontology aware label propagation (e.g., ontology aware propagator software 256), and ontology aware semantic blocking (e.g., ontology aware semantic blocking software 252) techniques to efficiently utilize the human labeled samples to train an effective GNN-based schema alignment model (e.g., machine learning model 230). In Algorithm 6 of FIG. 13F, lines 2 and 3 show how test samples and unlabeled (remaining) samples are created from the post-blocking pairs. In Algorithm 6, lines 1, 7 and 8 show the invocations to the semantic blocking, sample selection, and label propagation, respectively. The active learning framework is evaluated with respect to progressive F1-scores where the entire set of post-blocking pairs is treated as a test set. This gets a progressive quality measure for the model learned incrementally in each active learning iteration and also returns the number of labels required before the classifier reaches its convergent F1-score.

### 3.4.1 Computational Complexity of ALFA

The discussions of the computational complexity for each component in ALFA are below.

Ontology aware sample selection. The time complexity of K-means clustering (e.g., by clustering algorithm 262) in each AL iteration is O(I·n_{cluster}·|P_{remaining}|·d), where I is the number of K-means iterations until the convergence of clustering (e.g., 300 iterations by default in scikit), n_{cluster} is the number of clusters (e.g., 20 by default in ALFA), |P_{remaining}| is the number of remaining pairs, and d is the dimensionality of the RGCN model-generated embeddings (e.g., 64 feature vectors by default in ALFA) in each AL iteration. The time complexity of computing the label disagreement and the selection of top-k ambiguous pairs using a max-heap and a priority queue is O(|P_{remaining}|+k·log(k)). Thus, the time complexity of ontology-aware sample selection in ALFA is O(I·n_{cluster}·|P_{remaining}|·d+k·log(k)).

Ontology aware label propagation. If batchSize is the size of an AL batch and |cluster_{largest}| is the size of the largest K-means cluster, the time complexity of the selection of the candidate node pairs to which the oracle-assigned labels can potentially be propagated is O(batchSize·|cluster_{largest}|²). The time complexity of unrestricted mode is O(batchSize·|cluster_{largest}|²) and conservative mode is O(batchSize·(|cluster_{largest}|²+k·log(k))), where k is the top-k elements per Pair_{ref} to which the label is propagated. Last, the time complexity of the adaptive mode is O(batchSize·(|cluster_{largest}|²+iter·log(iter))), where iter is the numerical value of the AL iteration that is used as the dynamically changing value of k in the adaptive mode.

Semantic blocking. Among the two blocking variants of ALFA discussed in Section 3.3, the complexity of USESim is proportional to the size of the Cartesian product of the number of pairs across ontologies that can be written as O(|Ont_{L}|·|Ont_{R}|). Unlike USESim, the USECluster variant is not exhaustive and enumerates pairs only within the K-means clusters but not across clusters. Hence, the complexity of USESim is quadratic in the sizes of the clusters, but not in the sizes of the ontologies. If blocking_{cluster} is the number (#) of blocking clusters, the complexity of USESim is O(I·blocking_{cluster}·(|Ont_{L}|+|Ont_{R}|)·d+Σᵢ₌₁^{blocking}^{_{cluster}}|clusterᵢ|²)). Here, d is the dimensionality of the USE embeddings (e.g., 512 by default in ALFA) which is fed as input.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
generating, by a first machine learning model executed on a processor, node embeddings comprising node pairs of a first schema and a second schema;
predicting, by a second machine learning model executed on the processor, a label output for the node pairs;
clustering, by the processor, the node pairs into a cluster output;
determining, by the processor, that the label output and the cluster output are in a disagreement for at least one node pair of the node pairs; and
in response to displaying the at least one node pair to a subject matter expert to generate a label for the at least one node pair, using, by the processor, the label for the at least one node pair as training data to further train the second machine learning model.

2. The computer-implemented method of claim 1, further comprising determining that unlabeled node pairs of the node pairs are semantically similar to the at least one node pair; and
labeling the unlabeled node pairs having been determined with the label of the at least one node pair.

3. The computer-implemented method of claim 1, further comprising generating labeled node pairs by labeling unlabeled node pairs with the label of the at least one node pair, in response to the unlabeled node pairs being semantically similar to the at least one node pair; and
using the labeled node pairs having the label as further training data to train the second machine learning model.

4. The computer-implemented method of claim 3, wherein the labeled node pairs are applied at an adaptive rate as the further training data for training the second machine learning model, the adaptive rate increasing with each iteration of aligning the first schema and the second schema.

5. The computer-implemented method of claim 1, wherein determining that the label output and the cluster output are in the disagreement for the at least one node pair of the node pairs comprises: comparing a model similarity score associated with the label output to a clustering similarity score associated with the cluster output for the at least one node pair, and determining that a difference in the model similarity score and the clustering similarity score is greater than a threshold.

6. The computer-implemented method of claim 1, wherein the first machine learning model comprises a relational graph convolution network.

7. The computer-implemented method of claim 1, wherein the second machine learning model comprises a classifier.

8. A system comprising:
a memory having computer readable instructions; and
a computer for executing the computer readable instructions, the computer readable instructions controlling the computer to perform operations comprising:
generating, by a first machine learning model, node embeddings comprising node pairs of a first schema and a second schema;
predicting, by a second machine learning model, a label output for the node pairs;
clustering the node pairs into a cluster output;
determining that the label output and the cluster output are in a disagreement for at least one node pair of the node pairs; and
in response to displaying the at least one node pair to a subject matter expert to generate a label for the at least one node pair, using the label for the at least one node pair as training data to further train the second machine learning model.

9. The system of claim 8, wherein the computer performs the operations further comprising determining that unlabeled node pairs of the node pairs are semantically similar to the at least one node pair; and
labeling the unlabeled node pairs having been determined with the label of the at least one node pair.

10. The system of claim 8, wherein the computer performs the operations further comprising generating labeled node pairs by labeling unlabeled node pairs with the label of the at least one node pair, in response to the unlabeled node pairs being semantically similar to the at least one node pair; and
using the labeled node pairs having the label as further training data to train the second machine learning model.

11. The system of claim 10, wherein the labeled node pairs are applied at an adaptive rate as the further training data for training the second machine learning model, the adaptive rate increasing with each iteration of aligning the first schema and the second schema.

12. The system of claim 8, wherein determining that the label output and the cluster output are in the disagreement for the at least one node pair of the node pairs comprises: comparing a model similarity score associated with the label output to a clustering similarity score associated with the cluster output for the at least one node pair, and determining that a difference in the model similarity score and the clustering similarity score is greater than a threshold.

13. The system of claim 8, wherein the first machine learning model comprises a relational graph convolution network.

14. The system of claim 8, wherein the second machine learning model comprises a classifier.

15. A computer program product comprising a computer readable storage medium having program instructions embodied therewith, the program instructions executable by a computer to cause the computer to perform operations comprising:
generating, by a first machine learning model, node embeddings comprising node pairs of a first schema and a second schema;
predicting, by a second machine learning model, a label output for the node pairs;
clustering the node pairs into a cluster output;
determining that the label output and the cluster output are in a disagreement for at least one node pair of the node pairs; and
in response to displaying the at least one node pair to a subject matter expert to generate a label for the at least one node pair, using the label for the at least one node pair as training data to further train the second machine learning model.

16. The computer program product of claim 15, wherein the computer performs the operations further comprising determining that unlabeled node pairs of the node pairs are semantically similar to the at least one node pair; and
labeling the unlabeled node pairs having been determined with the label of the at least one node pair.

17. The computer program product of claim 15, wherein the computer performs the operations further comprising generating labeled node pairs by labeling unlabeled node pairs with the label of the at least one node pair, in response to the unlabeled node pairs being semantically similar to the at least one node pair; and
using the labeled node pairs having the label as further training data to train the second machine learning model.

18. The computer program product of claim 17, wherein the labeled node pairs are applied at an adaptive rate as the further training data for training the second machine learning model, the adaptive rate increasing with each iteration of aligning the first schema and the second schema.

19. The computer program product of claim 15, wherein determining that the label output and the cluster output are in the disagreement for the at least one node pair of the node pairs comprises: comparing a model similarity score associated with the label output to a clustering similarity score associated with the cluster output for the at least one node pair, and determining that a difference in the model similarity score and the clustering similarity score is greater than a threshold.

20. The computer program product of claim 15, wherein the first machine learning model comprises a relational graph convolution network.
